(19) United States
(12) Patent Application Publication
(10) Pub. No.: US 2026/0289052 A1
(43) Pub. Date: Sep. 24, 2026

(54) SYSTEM

(71) Applicant: SoftBank Group Corp., Tokyo (JP)

(72) Inventor: Jumpei FUJINO, Tokyo (JP)

(73) Assignee: SoftBank Group Corp., Tokyo (JP)

(21) Appl. No.: 19/568,836

(22) Filed: Mar. 17, 2026

(30) Foreign Application Priority Data
Mar. 19, 2025 (JP) 2025-045163

(51) Int. Cl. G06F 30/27; G06F 30/12; G06F 30/17; G06F 111/10; G06F 119/18; G10L 15/16; G10L 15/18; G10L 15/22

(52) U.S. Cl. CPC G06F 30/27; G06F 30/12; G06F 30/17; G10L 15/16; G10L 15/1822; G10L 15/22; G06F 2111/10; G06F 2119/18; G10L 2015/223

(57) ABSTRACT

A system includes a processor that is configured to collect and train, using a generative artificial intelligence plugin, data of various pieces of furniture and articles, generate and input, based on natural language dialog with a user, a prompt for instructing a generative AI model to generate a design or layout, and store a generated design in a digital format and publish and share the generated design via an online platform.

### CROSS-REFERENCE TO RELATED APPLICATION

This application is based on and claims priority under 35 USC 119 from Japanese Patent Application No. 2025-045163 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional design tools for furniture, articles, and clothing typically require specialized skills, complex computer-aided design (CAD) software, or manual drafting techniques, and therefore are not easily accessible to general users who wish to design and manufacture custom items suited to their own living spaces or bodies. In addition, existing online platforms that share design data often provide static files that are not generated or adapted in response to a user's natural language needs, and that do not readily translate into step-by-step procedures that a user can follow to perform do-it-yourself (DIY) manufacturing. Furthermore, although generative artificial intelligence technologies have advanced, they are not fully integrated into a unified system that: (i) collects and trains on diverse data of furniture, articles, and clothing, (ii) accepts natural language dialog from users to generate design prompts, and (iii) outputs shareable, digital-format designs including concrete manufacturing procedures and, in the case of clothing, simulations in virtual spaces. There is therefore a need for a system that leverages generative artificial intelligence plugins to lower the barrier to custom design creation, to automatically generate usable DIY recipes and design data from natural language interaction, and to facilitate publication and sharing of such generated designs via online platforms.

### SUMMARY

In order to solve the above-described problems, the invention provides a system comprising a processor, wherein the processor is configured to collect and train, using a generative artificial intelligence plugin, data of various pieces of furniture and articles, to generate and input, based on natural language dialog with a user, a prompt for instructing a generative AI model to generate a design or layout, and to store a generated design in a digital format and publish and share the generated design via an online platform. In one aspect, the processor is configured to cause the generated design to provide specific procedures for enabling a user to manually manufacture furniture or articles suitable for a living space or environment of the user, and to enable the user to perform manufacturing by following the specific procedures, thereby transforming abstract design concepts received in natural language into actionable DIY recipes. In another aspect, the processor is configured to collect, in addition to data of furniture and articles, data of clothing, to train the generative AI model using the data of clothing, and thereby to enable generation of clothing designs and simulation of placement of the clothing in a virtual space, so that users can obtain personalized clothing patterns and visualize their usage in digital environments. By these means, the system integrates data collection, AI-based design generation, DIY procedure generation, and online publication and sharing into a unified platform that allows general users to easily create, use, and disseminate customized designs.

The term “system” refers to an arrangement of hardware and software components including at least one processor configured to execute programmed instructions to perform the functions described in the claims.

The term “processor” refers to any circuit, device, or combination of hardware and software, such as a central processing unit (CPU), microprocessor, microcontroller, or programmable logic, that executes instructions to perform data processing and control operations.

The term “generative artificial intelligence plugin” refers to a software component or interface that enables a generative artificial intelligence model, such as a generative language model or generative design model, to be invoked or utilized by other software or systems to generate outputs including designs, layouts, or textual content.

The term “data of various pieces of furniture and articles” refers to digital information describing physical items including, but not limited to, furniture, household goods, tools, and other tangible objects, the information including attributes such as shape, dimensions, materials, colors, styles, usage contexts, and metadata.

The term “natural language dialog” refers to an interaction in which a user inputs statements, questions, or requests expressed in a human language, such as English or Japanese, and receives responses, such that the interaction proceeds in a conversational manner without requiring programming languages or specialized command syntax.

The term “prompt” refers to a text or structured input that is formed based on user-provided natural language dialog and that is supplied to a generative AI model as an instruction or context for generating an output such as a design or layout.

The term “generative AI model” refers to an artificial intelligence model, including but not limited to a neural network model, machine learning model, or large language model, that is capable of producing new data or content, such as designs, layouts, text, images, or patterns, based on training data and input prompts.

The term “design” refers to a representation of the structure, appearance, and configuration of a piece of furniture, article, or clothing, including, for example, geometries, dimensions, patterns, and aesthetic features, which can be used as a basis for manufacturing or visualization.

The term “layout” refers to an arrangement or positioning plan for one or more items, such as furniture, articles, or clothing, in a physical or virtual environment, including information about spatial placement, orientation, and relationships among the items.

The term “digital format” refers to an electronic representation of information, such as a file, data structure, or encoded dataset, that can be stored, processed, transmitted, displayed, or edited by computing devices.

The term “online platform” refers to a network-connected service, website, or application that enables storage, access, publication, and sharing of digital content via the Internet or another communication network.

The term “publish and share” refers to making generated designs available, through an online platform, to one or more users other than the creator, and optionally allowing access, viewing, downloading, copying, rating, commenting, or reuse of the designs.

The term “generated design” refers to a design or layout output that is produced by a generative AI model in response to a prompt derived from user dialog and data of furniture, articles, or clothing.

The term “specific procedures” refers to a set of concrete, ordered steps or instructions, which may include dimensions, materials, tools, operations, and sequences, that guide a user in manufacturing or assembling a physical item.

The term “living space or environment of the user” refers to a physical area in which the user resides, works, or makes use of furniture or articles, such as a room, house, office, or other interior or exterior space, characterized by dimensions, layout, and aesthetic conditions.

The term “manually manufacture” refers to the act of creating, assembling, or constructing a physical item by a user using tools, materials, and the user's labor, as opposed to fully automated or industrial mass production.

The term “data of clothing” refers to digital information describing garments or wearable articles, including attributes such as type, pattern, size, measurements, materials, colors, styles, and intended fit.

The term “clothing designs” refers to generated representations of garments or wearable items, including pattern shapes, cutting lines, seam positions, sizes, and aesthetic features, which can be used for tailoring, sewing, or virtual visualization.

The term “simulation of placement of the clothing in a virtual space” refers to a computational representation or visualization in which a clothing design is positioned, rendered, or animated within a digital environment, such as on a virtual mannequin, avatar, or in a three-dimensional scene, to show how the clothing would appear when worn or placed.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

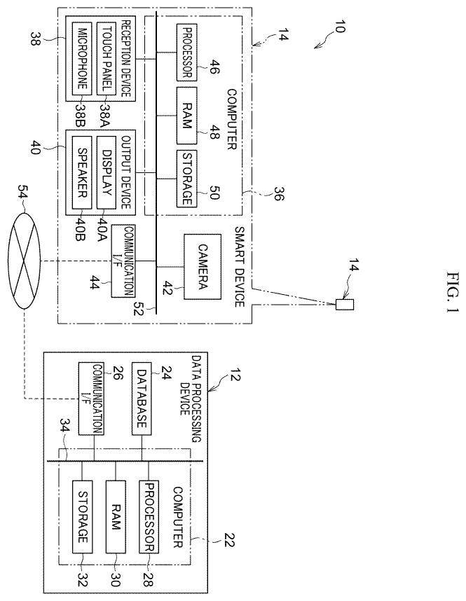

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

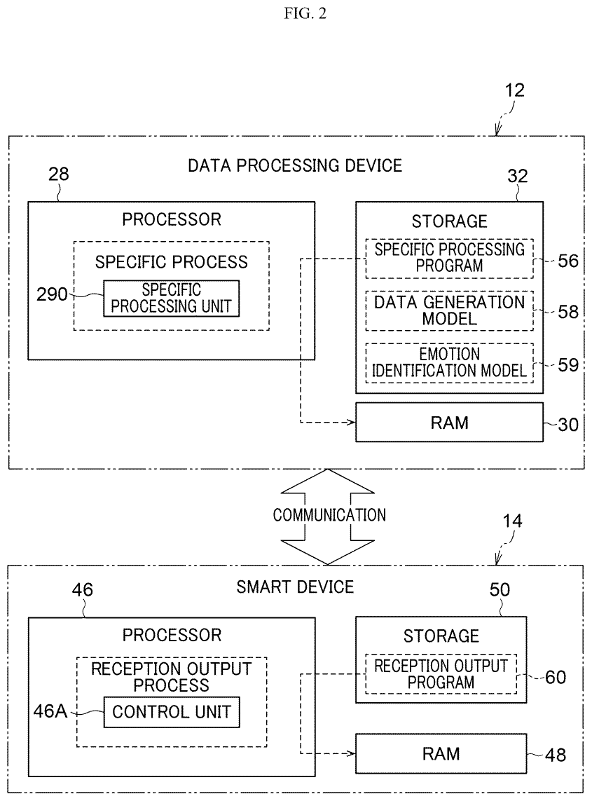

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented design support techniques for articles such as furniture, general goods, and garments exhibit several technical deficiencies in terms of data processing and system architecture. In many existing solutions, attribute information and image information of articles are stored in heterogeneous and unstructured forms, making it difficult for a computing system to efficiently supply such information as training data to a generative artificial intelligence model. As a result, model training often requires manual preprocessing or ad hoc data pipelines, which increases computational overhead, latency, and the likelihood of inconsistent model behavior.

Furthermore, in conventional systems, the interaction between a user and a generative artificial intelligence model is typically limited to simple text input and static output, without an integrated feedback loop that allows iterative modification of design parameters and automatic regeneration of three-dimensional model data. This separation of generative processing and three-dimensional modeling forces the user or an external application to perform repeated manual conversions and adjustments, thereby increasing processing time, consuming additional computing resources, and degrading the responsiveness and usability of the overall system.

In addition, known systems often specialize in a narrow category of articles and are not configured to robustly handle multiple article categories using a common generative artificial intelligence model. When expanding to multiple categories such as furniture, general articles, and garments, conventional architectures tend to require separate models or separate data processing pipelines, leading to duplication of computing resources and fragmentation of training data. Consequently, it becomes difficult for the computational infrastructure to efficiently identify a target article category from a natural language prompt sentence and to generate consistent design information and three-dimensional model data across different categories.

Moreover, existing online platforms that display three-dimensional design results frequently treat generative processing, three-dimensional visualization, and sharing functions as independent subsystems. This fragmented configuration makes it difficult to maintain end-to-end consistency in data formats, metadata, and virtual placement information, which in turn impairs the system's ability to render and update three-dimensional models in virtual environments in real time.

Accordingly, there is a need for improved computer technology that (i) structurally acquires and records attribute information and image information as unified training data for a generative artificial intelligence model, (ii) tightly integrates prompt sentence processing, generative inference, and three-dimensional model generation into a single server architecture, (iii) supports iterative update of design information and automatic regeneration of three-dimensional model data in response to user feedback, and (iv) handles multiple article categories and virtual space placement using a common generative artificial intelligence model and a consistent data representation.

The specific processing by the specific processing unit 290 of the data processing device 12 in Example 1 is realized by the following means.

The present invention provides a server comprising a processor configured to acquire an information set including attribute information relating to an article and to record the information set as structured information including the attribute information and image information in a storage device in order to provide learning information to a generative artificial intelligence model, to train the generative artificial intelligence model by using a machine learning framework on the basis of the structured information and to update parameters of the generative artificial intelligence model so that the generative artificial intelligence model is capable of outputting design information of the article in response to an input of a prompt sentence, to obtain, via a communication device, the prompt sentence described in natural language from a user and to convert the prompt sentence into an internal representation that is inputtable to the generative artificial intelligence model, to input the internal representation to the generative artificial intelligence model and to cause the generative artificial intelligence model to generate the design information including design parameters and external shape parameters of the article corresponding to the prompt sentence, to perform three-dimensional shape generation processing on the basis of the design information to generate three-dimensional model data representing the article and to output the three-dimensional model data in a standardized digital data format, to store the three-dimensional model data and the design information in association with management information in the storage device and to distribute the three-dimensional model data and the design information as publication information via an online platform so that the three-dimensional model data and the design information are shareable among a plurality of users, and optionally to transmit the three-dimensional model data to a terminal of the user, to obtain dimension change information or appearance change information from the user, to update the design information on the basis of the dimension change information or the appearance change information, to regenerate the three-dimensional model data on the basis of the updated design information, to train the generative artificial intelligence model on the basis of attribute information common to a plurality of article categories, to identify an article category included in the prompt sentence, and to generate placement information of the three-dimensional model data in a virtual space. This enables an integrated computer-implemented pipeline in which structured training data are automatically prepared and supplied to a single generative artificial intelligence model, natural language prompt sentences are programmatically converted into internal representations for inference, design information and three-dimensional model data are generated and regenerated in response to user feedback, and multi-category articles and their virtual placement are processed and distributed through a unified server architecture, thereby improving computational efficiency, responsiveness, and consistency of the design generation and sharing system.

The term “processor” refers to a hardware circuit or a combination of hardware circuits which executes computer-readable instructions, and may include one or more central processing units, graphics processing units, or other computation units.

The term “storage device” refers to a hardware component configured to store data or programs, and may include volatile memory, non-volatile memory, magnetic storage, optical storage, or a combination thereof.

The term “communication device” refers to a hardware component or interface configured to transmit and receive data between the server and an external apparatus over a wired or wireless network.

The term “information set” refers to a collection of data elements relating to one or more articles, the collection including at least attribute information and optionally including image information, identifier information, or other descriptive information.

The term “attribute information” refers to data indicating properties of an article, including at least one of a category, a shape, a color, a material, a size, a function, or a style.

The term “image information” refers to digital image data representing at least a part of an appearance of an article, and may include still images, image sequences, or encoded image features.

The term “structured information” refers to data organized according to a predetermined format or schema such that fields corresponding to attribute information, image information, and management information are explicitly identifiable.

The term “management information” refers to control data used to manage design information and three-dimensional model data, including at least one of an identifier, a version, a creator identifier, a timestamp, a category label, or an access permission.

The term “generative artificial intelligence model” refers to a machine-learned model that has been trained using training data so as to output new data, including design information, in response to input data, and that performs at least one of probabilistic sampling, sequence generation, or parameter prediction.

The term “machine learning framework” refers to a software environment or library that provides functions for defining, training, and executing a machine-learned model, including at least functions for numerical computation, gradient calculation, and parameter updating.

The term “prompt sentence” refers to a sequence of characters expressed in a natural language and supplied by a user to instruct the generative artificial intelligence model to generate design information for an article.

The term “internal representation” refers to a data structure obtained by converting a prompt sentence or other external input into a form suitable for processing by the generative artificial intelligence model, and may include token identifiers, numerical vectors, or feature tensors.

The term “design information” refers to data describing a design of an article, and includes at least design parameters and external shape parameters used to generate a three-dimensional representation of the article.

The term “design parameters” refers to numerical or categorical values that define configurable aspects of an article, including at least dimensions, arrangement of parts, style attributes, material types, or functional options.

The term “external shape parameters” refers to data that specify geometric features of an outer shape of an article, including at least coordinates, lengths, angles, radii, cross-sectional shapes, or topological relationships.

The term “three-dimensional model data” refers to digital data representing an article in a three-dimensional space, and may include mesh data, polygon data, surface data, volumetric data, or a combination thereof.

The term “standardized digital data format” refers to a file format or data format conforming to a predetermined specification for representing three-dimensional model data, such that the data are interpretable by multiple independent software applications.

The term “three-dimensional shape generation processing” refers to computational operations that convert design information, including design parameters and external shape parameters, into three-dimensional model data by creating and arranging geometric primitives or surfaces.

The term “online platform” refers to a computer-implemented service accessible via a network, which is configured to store, manage, distribute, or display design information and three-dimensional model data for one or more users.

The term “publication information” refers to data that is made accessible to one or more users via the online platform, the data including at least design information, three-dimensional model data, or metadata associated with such information or data.

The term “terminal” refers to an information processing apparatus used by a user to communicate with the server, and may include a personal computer, a tablet device, a smartphone, or another network-connected device.

The term “three-dimensional display software” refers to a software program or library configured to render three-dimensional model data on a display unit of a terminal and to provide at least one of rotation, translation, zooming, or viewpoint control.

The term “dimension change information” refers to data indicating an instruction from a user to change at least one dimensional parameter of an article, including at least width, height, depth, thickness, or spacing.

The term “appearance change information” refers to data indicating an instruction from a user to change at least one visual attribute of an article, including at least color, texture, surface finish, pattern, or decorative element.

The term “article category” refers to a classification of articles according to type or use, including at least furniture, general goods, garments, or other categories of manufactured or designed items.

The term “virtual space” refers to a computer-generated three-dimensional environment in which one or more three-dimensional model data items can be positioned, oriented, and displayed.

The term “placement information” refers to data indicating at least one of a position, an orientation, or a scale of three-dimensional model data within the virtual space, and may further include layer information, interaction information, or scene configuration information.

The term “user” refers to a human operator who interacts with the server and the terminal in order to provide prompt sentences, review generated designs, and optionally modify or approve design information.

The term “plurality of users” refers to two or more users who are capable of accessing design information or three-dimensional model data via the online platform, either concurrently or at different times.

In the following embodiments, a server, a terminal, and a user cooperate to implement the claimed system. The same reference terms are used consistently with the claims and the definitions described above.

### 1. Overall System Configuration

A server includes a processor, a storage device, and a communication device. The processor may include one or more central processing units and, in some embodiments, one or more graphics processing units. The storage device includes a volatile memory and a non-volatile memory, and stores structured information, a generative artificial intelligence model, three-dimensional model data, and management information. The communication device connects the server to one or more terminals via a network such as the Internet.

A terminal includes a processor, a display unit, an input device, a local storage, and a communication interface. The terminal executes a web browser or a dedicated application program to transmit and receive data with the server and to display three-dimensional models to the user.

The user operates the terminal to provide attribute information and prompt sentences, to view generated design information and three-dimensional model data, and to optionally modify design parameters.

### 2. Data Acquisition and Structuring

The user collects attribute information and image information of articles such as furniture, general goods, and garments. The user uses the terminal to upload digital image files and to input textual descriptions.

The terminal presents an input interface implemented, for example, by a hypertext-based application or a graphical user interface. The terminal allows the user to specify at least a category, a shape description, dimensions, materials, colors, and style attributes. The terminal transmits the input data to the server through the communication device using a communication protocol such as HTTPS.

The server receives the input data and stores the raw image files in a file system or an object storage system. The server converts the textual attribute information into a structured format such as records having fields for category, shape, dimensions, materials, and other properties. The server stores the structured information in the storage device as relational records or key-value objects.

For example, the user may submit attribute information describing a wooden dining table. The user may input “dining table” as the category, “rectangular top with four legs” as the shape description, “120 cm” as width, “60 cm” as depth, “75 cm” as height, “solid wood” as material, and “natural brown” as color. The terminal transmits these values to the server, and the server records them in a structured record associated with one or more image files of the table.

The server thereby creates an information set composed of attribute information and associated image information, and stores it as structured information. This unified data structure reduces later preprocessing complexity and improves training efficiency of the generative artificial intelligence model.

### 3. Preprocessing and Feature Extraction

The server executes preprocessing programs stored in the storage device. The processor of the server reads structured information and performs text processing and image processing to generate feature representations suitable for training.

The server converts textual attribute fields into canonical forms by applying operations such as case normalization, removal of stop words, and tokenization. The server assigns vocabulary indices to tokens and generates token sequences. The server converts categorical attributes such as category, material, and style into integer labels or one-hot vectors. The server normalizes numeric attributes such as width, depth, and height by applying a scaling function to map values into a predetermined numeric range.

The server processes images by resizing them to fixed dimensions and normalizing pixel values. The server may apply data augmentation operations such as random rotation, cropping, or color perturbation to increase the robustness of the model. The server may generate intermediate feature maps using a convolutional neural network encoder and store the encoded features in the storage device for later use.

The server thus generates a training dataset in which each article is represented as a set of text-derived features, numeric attributes, categorical attributes, and, in some embodiments, image-derived features. This explicit feature structure improves the convergence speed and stability of the training process compared to systems that rely only on unstructured natural language descriptions.

### 4. Generative Artificial Intelligence Model Architecture

The server constructs a generative artificial intelligence model as a neural network architecture. In one embodiment, the generative artificial intelligence model includes an encoder-decoder structure with attention mechanisms.

The server defines an encoder that receives token sequences representing a prompt sentence and structured attributes, and maps them to contextual vector representations. The encoder may be implemented as a multi-layer transformer-type network with self-attention blocks, normalization layers, and feedforward layers. The server defines a decoder that generates design parameters and external shape parameters as output sequences or as vectors. The decoder may receive the encoder output and generate, for example, dimension values, material choices, style labels, and geometric parameter sets.

The server may include additional sub-networks that map the decoder output to parametric representations suitable for three-dimensional geometry generation. For example, the server may use a fully connected network to map a latent vector to a table of geometric primitives such as rectangular prisms, cylinders, and their arrangement parameters.

In another embodiment, the server uses a conditional variational autoencoder that inputs a prompt sentence and outputs design parameters conditioned on latent variables representing style and category. In yet another embodiment, the server uses a conditional generative adversarial network, where a generator network outputs design parameter sets and a discriminator network evaluates whether the generated parameter sets are consistent with the training data distribution.

### 5. Training Method and Optimization

The server trains the generative artificial intelligence model by reading the preprocessed training dataset from the storage device. The server divides the dataset into batches and iteratively processes the batches.

The server computes forward passes of the encoder and decoder for each batch. The server calculates loss values consisting of one or more components such as reconstruction loss between predicted design parameters and ground-truth parameters, classification loss for category labels, and, in some embodiments, adversarial loss for realism. The server may use mean squared error for numeric parameters, cross-entropy loss for categorical labels, and Kullback-Leibler divergence for latent variable regularization.

The server updates model parameters by calculating gradients of the loss with respect to parameters and performing parameter updates using an optimization algorithm such as stochastic gradient descent or adaptive moment estimation. The server may perform gradient clipping, learning rate scheduling, and early stopping based on validation loss to improve stability.

The server periodically evaluates the model on a validation dataset and records performance metrics such as average deviation of generated dimensions from ground truth, correctness rate of material predictions, and diversity of generated shapes. By executing these training steps in a structured and automated manner, the server reduces human intervention and improves the reproducibility and accuracy of the generative process.

### 6. Prompt Sentence Processing

The user requests a new design by entering a prompt sentence via the terminal. The terminal displays an input field on a graphical interface. The user types a natural language instruction. For example, the user may input:

“Generate a modern wooden dining table with a natural brown color, 120 cm wide, 60 cm deep, and 75 cm high.”

In another example, the user may input:

“Create a compact bedside table with one drawer, made of light oak, suitable for Scandinavian interior design.”

The terminal transmits the prompt sentence to the server.

The server receives the prompt sentence and applies the same tokenization and normalization procedures as in the training phase. The server identifies numerical expressions and converts them into normalized dimension values. The server identifies key terms such as category and style, and generates an internal representation consisting of token indices, numerical vectors, and category indicators. Because the server uses the same feature schema as used during training, the internal representation aligns with the learned feature space, which improves inference accuracy and reduces the need for ad hoc parsing.

### 7. Inference and Design Information Generation

The server inputs the internal representation into the trained generative artificial intelligence model. The encoder generates contextual vectors representing the semantic content of the prompt sentence and the extracted attributes. The decoder generates design parameters and external shape parameters.

The server may use a controlled decoding method in which numeric values are generated within prespecified bounds and categorical labels are selected from allowed sets. The server may correct or adjust outputs that violate physical constraints such as negative dimensions or impossible arrangements.

For example, in response to the prompt sentence for a dining table, the generative model may output design parameters including width 1200 mm, depth 600 mm, height 750 mm, top thickness 25 mm, leg thickness 45 mm, corner radius 10 mm, and style “modern”. The model may output a leg arrangement indicating four legs at specified offsets from the corners.

The server stores the generated design information as a structured record including all design parameters and external shape parameters. Because the design information is represented as explicit numeric and categorical fields, subsequent three-dimensional geometry generation can be implemented as deterministic, verifiable transformations, which improves reproducibility and error detection.

### 8. Three-Dimensional Model Generation

The server generates three-dimensional model data from the design information. The server executes a geometry module that creates three-dimensional primitives based on the design parameters.

The server may implement the geometry module using a three-dimensional modeling library. The server computes vertex coordinates and face indices for geometric primitives such as a top plate and legs. The server applies geometric transformations such as translation, scaling, and rotation. The server computes corner rounding surfaces based on corner radius parameters. The server assigns material identifiers and color attributes to mesh elements. The server then encodes the resulting geometry into a standardized digital data format such as a polygon mesh format. The server may compress or optimize the mesh by reducing the number of vertices in flat regions while maintaining geometric fidelity.

This direct, programmatic transformation from structured design parameters to three-dimensional model data significantly reduces computational overhead compared to systems that reconstruct three-dimensional shapes from unstructured outputs. The explicit geometry pipeline also facilitates automated verification such as checking for intersections or structural inconsistencies.

### 9. Distribution and Visualization

The server stores the generated three-dimensional model data and design information in the storage device together with management information such as identifiers, timestamps, and category labels. The server generates metadata and publication information.

The server transmits the three-dimensional model data or references thereto to the terminal. The terminal retrieves and loads the three-dimensional model data and uses three-dimensional display software to render the model. The terminal may provide interactive controls for rotation, zooming, and inspection of dimensions.

By using a standardized digital data format and consistent metadata, the server reduces the need for format conversion and manual configuration, thereby improving display speed and reliability on various terminals.

### 10. Iterative Modification and Regeneration

The user may inspect the three-dimensional model and decide to modify certain aspects. The user uses the terminal to change values such as width, height, or color, or to input an additional prompt sentence describing changes.

For example, the user may input:

“Make the table legs slightly thicker and reduce the height to 70 cm.”

The terminal sends modification data to the server. The server updates the design information by replacing affected design parameters and optionally re-invoking the generative artificial intelligence model with the modification context. The server regenerates three-dimensional model data based on updated design information.

Because the geometry module operates directly on design parameters, the server can regenerate the three-dimensional model rapidly without performing full retraining of the model. This yields a low-latency feedback loop between user input and visual output, which improves system responsiveness and reduces redundant computation.

### 11. Multi-Category Support and Virtual Placement

In some embodiments, the server trains the generative artificial intelligence model on multiple article categories. The server includes a category embedding that represents each category as a vector. During training, the server inputs category labels together with attribute features and prompts, and the model learns correlations between categories and typical design configurations.

When the server receives a prompt sentence, the server infers or obtains the article category from explicit terms such as “table”, “chair”, or “dress”. The server sets the category embedding accordingly and feeds it to the generative model. The generative model outputs design parameters consistent with the identified category.

The server may further generate placement information for virtual space. For example, the server may compute positions and orientations for multiple three-dimensional models in a virtual room or a virtual closet. The server stores placement information as vectors representing coordinates and rotations. The server transmits the placement information and three-dimensional model data to terminals or to an extended reality device. This enables users to visualize how the generated articles appear in a virtual environment, which supports technical use cases such as collision analysis or space utilization evaluation.

### 12. Technical Effects and Improvement of Computer Technology

The server improves computer technology in several respects.

First, by representing attribute information, prompt sentences, design parameters, and external shape parameters as consistent, structured feature sets, and by aligning training and inference pipelines, the server reduces preprocessing overhead and increases the accuracy of generative outputs. This structure avoids repeated ad hoc parsing and reduces error propagation, which leads to more stable computation.

Second, the integration of the generative artificial intelligence model with a parametric geometry module inside a single server architecture allows efficient end-to-end processing. The server converts normalized design parameters into three-dimensional model data directly, without requiring manual modeling or post-processing by external software. This reduces round-trip communication and eliminates intermediate file conversions. Third, the use of a dedicated loss function configuration and training schedule improves the predictive accuracy of dimensions and shapes. Because the server explicitly penalizes deviations in dimensional parameters and shape parameters, the model learns to produce outputs that closely match feasible designs. This reduces the amount of manual correction required and allows the system to operate with fewer iterations.

Fourth, the iterative update mechanism, in which dimension change information and appearance change information are directly incorporated into design information and geometry generation, enables fast regeneration of three-dimensional models using incremental updates rather than complete recomputation. This reduces computational load and network traffic compared to systems that regenerate entire models from scratch for each small modification.

Fifth, the multi-category training approach allows one generative artificial intelligence model to handle multiple article categories with shared feature representations. This reduces memory usage, simplifies deployment, and improves generalization compared to systems that maintain separate models for each category.

By these configurations and flows, the server does not merely automate human design tasks but modifies the way in which data is structured, processed, and transformed inside the computer. The claimed system improves computational efficiency, precision of generated three-dimensional models, data management consistency, and responsiveness of design generation, thereby providing a concrete improvement in computer technology.

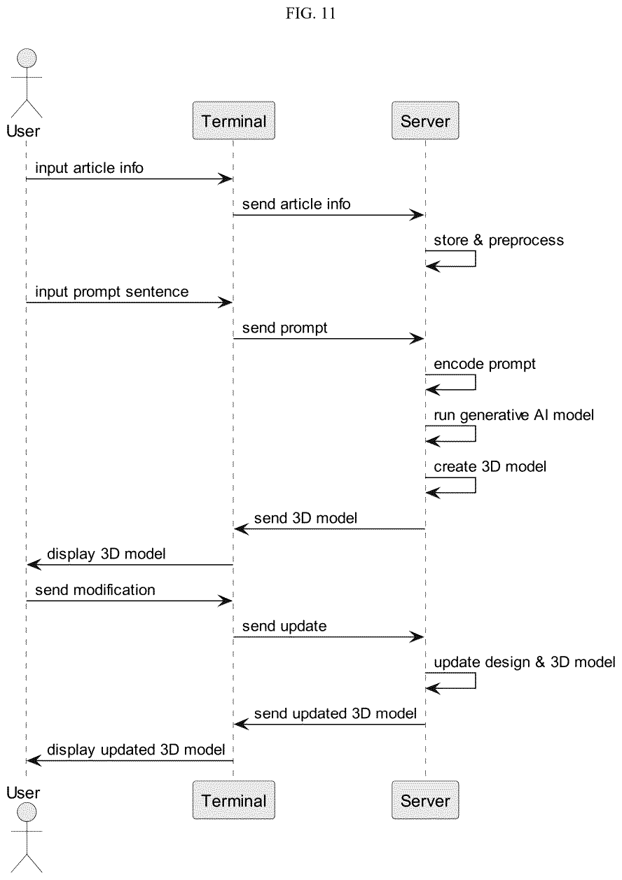

The following describes the processing flow using FIG. 11.

### Step 1:

The user prepares article information.

The user uses the terminal to capture or select image files of an article and to input attribute information such as category, shape description, dimensions, material, color, and style as text. The input in this step is raw user data including image files and textual attribute descriptions. The user triggers a send operation on the terminal, and the terminal packages the image files and attribute information into a structured message (for example, a multipart HTTP request) and transmits the message to the server.

The output of this step is a data transmission request containing user-provided article information.

### Step 2:

The terminal structures and transmits input data.

The terminal receives the user's image selection and attribute entries from the input interface and validates that required fields are not empty and that dimensions are numerically valid. The input in this step is the set of user-entered values and selected files.

The terminal converts the text fields into a preliminary structured format, such as a JSON object with keys “category”, “shape_description”, “width”, “height”, “depth”, “material”, and “color”, and attaches the image files. The terminal then sends this structured payload to the server via a communication interface using a network protocol.

The output of this step is a structured payload delivered to the server that is ready for server-side processing.

### Step 3:

The server receives and stores raw article data.

The server receives the structured payload from the terminal and parses the message to separate image data from textual attribute data.

The input in this step is the structured payload containing images and attribute fields.

The server writes the image data into an image storage area of the storage device and records file paths or identifiers. The server converts the attribute text into a normalized record structure, assigns a unique article identifier, and stores the record in a data table together with references to the stored images.

The output of this step is a persistent, structured record that links attribute information and image information via an internal identifier.

### Step 4:

The server preprocesses attribute text and images.

The server periodically or on demand reads stored article records and associated images from the storage device to generate training-ready features.

The input in this step is the set of article records, each including attribute text fields, numeric fields, categorical fields, and image file paths.

The server performs text normalization (for example, lowercasing and removal of special symbols), tokenization into word or subword units, and mapping of tokens to integer indices using a vocabulary. The server converts categorical attributes into one-hot vectors or embedding indices, and scales numeric dimensions into a normalized numeric range using a linear transformation. For images, the server resizes each image to a fixed resolution, normalizes pixel intensity values, and optionally performs augmentation such as rotation or cropping.

The output of this step is a set of feature tensors and labels stored in the storage device in a format suitable for input to the generative AI model.

### Step 5:

The server trains the generative AI model.

The server loads the preprocessed feature tensors and labels and initializes a neural network model that serves as the generative AI model.

The input in this step is the training dataset consisting of prompt-related features (e.g., text tokens and attribute vectors) and corresponding target design parameters and external shape parameters.

The server iteratively executes a training loop in which the server feeds batches of training data into the model, computes forward passes to obtain predicted design parameters, calculates loss values such as mean squared error for numeric parameters and cross-entropy for categorical parameters, and backpropagates gradients to update weights using an optimization algorithm. The server may also apply regularization, dropout, and learning rate scheduling.

The output of this step is a trained set of model parameters stored as a generative AI model ready for inference.

### Step 6:

The user composes a prompt sentence for design generation.

The user uses the terminal to open a design-generation interface and types a natural language prompt sentence describing the desired article.

The input in this step is the user's design intent expressed as a text string.

The user confirms the input, and the terminal reads the text string from the input field. For example, the user may input: “Generate a modern wooden dining table with a natural brown color, 120 cm wide, 60 cm deep, and 75 cm high.” or “Create a compact bedside table with one drawer, made of light oak, suitable for Scandinavian interior design.”

The output of this step is a prompt sentence held in the terminal's memory and prepared for transmission.

### Step 7:

The terminal transmits the prompt sentence.

The terminal receives the confirmed prompt sentence from the user interface and wraps the text in a request message.

The input in this step is the raw text of the prompt sentence.

The terminal may perform client-side checks, such as confirming that the length is within limits and encoding the text using a character encoding scheme. The terminal then sends the prompt sentence and an optional user identifier to the server via a network communication protocol.

The output of this step is a prompt request message arriving at the server.

### Step 8:

The server converts the prompt sentence into an internal representation.

The server receives the prompt request and extracts the prompt sentence text.

The input in this step is the natural language prompt sentence string and any associated metadata such as user ID or context ID.

The server applies the same tokenizer and vocabulary used in training to split the sentence into tokens and convert tokens into integer indices. The server scans the sentence to detect numeric expressions for dimensions and converts them into normalized numerical features.

The server also applies pattern matching or classifier logic to identify category and style terms. The server then combines token indices, numeric vectors, and category indicators into a unified internal representation tensor aligned with the generative AI model's input format.

The output of this step is an internal representation suitable as input to the generative AI model.

### Step 9:

The server generates design parameters and external shape parameters.

The server loads the trained generative AI model parameters into memory and feeds the internal representation from the previous step into the model.

The input in this step is the internal representation tensor and the trained model parameters.

The server performs a forward pass through the encoder to obtain contextual embeddings, and then through the decoder to predict design parameters and external shape parameters. The server may apply constrained decoding to restrict numeric outputs to valid ranges and categorical outputs to allowed values. The server post-processes the raw outputs by denormalizing dimension values back to real-world units and mapping categorical indices to human-readable labels.

The output of this step is a structured set of design parameters and external shape parameters representing a design that conforms to the prompt sentence.

### Step 10:

The server transforms design parameters into three-dimensional model data.

The server invokes a geometry generation module and supplies the generated design parameters and external shape parameters as input.

The input in this step is the structured design information including dimensions, part arrangements, and shape descriptors.

The server computes geometry by creating vertices and faces for geometric primitives corresponding to article components. The server calculates coordinates for a top surface, legs, shelves, or other parts according to dimension values and arrangement rules. The server applies transformations to shape edges or corners based on radius or bevel parameters and assigns material and color attributes to surfaces. The server then encodes the resulting mesh into a standardized digital data format and optionally performs mesh simplification to reduce vertex count.

The output of this step is three-dimensional model data stored as a file or data object in the storage device.

### Step 11:

The server stores and registers design data for publication.

The server associates the generated three-dimensional model data with design information and management information.

The input in this step is the three-dimensional model data and the corresponding design parameters and metadata.

The server writes the three-dimensional model data file to a storage area and records a database entry containing a unique design identifier, references to the file location, and fields such as category, style, and timestamps. The server flags the design as available for viewing or sharing on an online platform.

The output of this step is a registered design record that can be retrieved by the terminal via the online platform.

### Step 12:

The server provides three-dimensional model data to the terminal.

The server receives a request from the terminal to view or download the generated design and identifies the associated three-dimensional model data.

The input in this step is a design identifier or similar reference from the terminal.

The server reads the three-dimensional model data and, if necessary, generates or retrieves pre-rendered preview images. The server sends URLs or binary data of the three-dimensional model and related previews to the terminal using a network protocol.

The output of this step is a response message that allows the terminal to obtain and display the three-dimensional model.

### Step 13:

The terminal displays the three-dimensional model and design information.

The terminal receives the three-dimensional model data or its URL from the server.

The input in this step is the three-dimensional model file or a reference to it, along with design parameters for display.

The terminal loads the model into three-dimensional display software, sets up a virtual camera and lighting, and renders the model on the display. The terminal displays associated design parameters such as width, depth, height, material, and color alongside the rendered view. The user can rotate, zoom, and inspect the model via interactive controls. The output of this step is an interactive visual display enabling the user to evaluate the generated design.

### Step 14:

The user modifies the design by feedback.

The user inspects the three-dimensional model and may decide to adjust certain properties.

The input in this step is the user's evaluation of the displayed model.

The user uses the terminal to either directly change numeric values such as dimensions in a parameter panel or to enter an additional prompt sentence describing modifications, such as “Make the table legs slightly thicker and reduce the height to 70 cm.” The user then confirms the modifications, and the terminal collects the new values or text and prepares them for transmission.

The output of this step is modification data (dimension change information or appearance change information, or an additional prompt sentence) held by the terminal.

### Step 15:

The terminal sends modification data to the server.

The terminal packages the modification data into a request message, optionally including a reference to the current design identifier.

The input in this step is the modification data and the design identifier.

The terminal transmits the message to the server via the communication interface. The terminal may perform basic validation, such as checking that dimensions remain within allowed ranges, before transmission.

The output of this step is a modification request received by the server.

### Step 16:

The server updates design information and regenerates the three-dimensional model.

The server receives the modification request and identifies the design record to be updated.

The input in this step is the existing design information and the modification data from the terminal.

The server updates relevant design parameters based on the modification data. If the modification is provided as a new prompt sentence, the server converts the sentence into an internal representation and optionally uses the generative AI model to compute adjusted parameters while maintaining consistency with the original design. The server then re-executes the geometry generation module with updated parameters to produce a revised three-dimensional model.

The output of this step is updated design information and regenerated three-dimensional model data stored and associated with the same or a new design identifier.

### Step 17:

The server supports multi-category generation and virtual placement.

The server reads category information from the prompt sentence or from user selection and encodes it as part of the input to the generative AI model.

The input in this step is category labels and other attribute data related to the article.

The server uses category-specific embeddings and shared parameters in the generative AI model to generate design parameters tailored to the identified category. If virtual placement is requested, the server also computes placement information, including positions and orientations for the three-dimensional model within a virtual space scene. The server stores or transmits the placement information together with the model data so that the terminal or another device can render the article in a virtual environment.

The output of this step is category-consistent design information, three-dimensional model data, and optional placement information for use in virtual space visualization.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented design systems for three-dimensional objects, such as furnishing and other articles, generally rely on fixed templates or manually created models. In such systems, a user is often required to learn complex three-dimensional modeling tools, to manipulate low-level geometric primitives, or to navigate multiple disjoint applications for design generation, layout simulation, and sharing. As a result, there is a substantial gap between a user's intent, typically expressed in natural language, and the internal data structures used by the system, such as meshes, scene graphs, and rendering configurations. This gap forces the user or an operator to perform repeated manual translations and adjustments, which increases latency, reduces accuracy of reflecting user intent, and limits scalability.

Additionally, in many existing architectures, natural language interfaces, generative models, and three-dimensional visualization engines are loosely coupled or integrated only at the user interface level. For example, a generative model may output an image or a static file without structured integration into a virtual scene. In such cases, the system does not maintain an internal, machine-readable representation that consistently connects (i) prompt sentences provided by the user, (ii) structured semantic information derived from the prompt sentences, (iii) parameters of a generative AI model, and (iv) the configuration of the virtual environment. This lack of coordinated internal representations leads to inefficiencies in computing pipelines, including redundant data conversions, ad-hoc scripts for placing objects, and duplicated logic for incremental adjustments to a generated design. Further, when a user attempts to iteratively refine a design by providing additional natural language instructions, conventional systems frequently regenerate entire models or scenes from scratch. Such systems do not systematically associate a new prompt sentence with previously generated structured information and three-dimensional object data. Consequently, they cannot reliably extract modification parameters—such as changes in shape, dimension, color, or placement position—and apply them in a targeted manner. This causes unnecessary computation on processing resources, increases response time, and prevents fine-grained control over the design and simulation process from the standpoint of system efficiency. Moreover, known platforms for sharing generated designs usually treat the design as a static asset and do not expose machine-interpretable metadata that reflects the original prompt sentences, the structured semantic attributes, or the generative pipeline that produced the designs. As a result, downstream systems or third-party terminals cannot easily reuse or recontextualize the generated designs within their own virtual spaces, and cannot leverage accumulated prompt-design pairs to improve later inference or to adapt the generative models.

Therefore, there is a need for a computer-implemented system that improves the overall architecture and processing pipeline by: (i) tightly integrating natural language processing, generative AI model execution, and virtual scene configuration; (ii) establishing explicit internal structures that map prompt sentences to structured semantic information and three-dimensional object data; (iii) enabling efficient, parameter-level iterative refinement of generated objects and scenes; and (iv) providing a way to store and share generated designs with their associated metadata in a form that is readily reusable by other computing entities. Such a system would constitute an improvement to computer technology itself, by reorganizing data flows and processing sequences to reduce computational redundancy, latency, and manual intervention in three-dimensional content generation and simulation.

The specific processing by the specific processing unit 290 of the data processing device 12 in Application Example 1 is realized by the following means.

The present invention provides a server comprising a processor and a memory storing instructions which, when executed by the processor, cause the processor to: receive, via a communication interface from a terminal, a prompt sentence expressed in natural language; apply a natural language processing procedure to the prompt sentence to generate structured information indicating at least a type of object, a style, a target placement space, and one or more attribute conditions; generate, based on the structured information, a model-input prompt sentence suitable for a generative AI model; access a set of object data, stored in a storage resource, the set of object data including attribute data associated with multiple categories of objects; execute the generative AI model on a computation resource using the model-input prompt sentence and the set of object data to generate three-dimensional object data or parametric design information including shape information, appearance information, and material information of an object; convert the generated three-dimensional object data or parametric design information into a three-dimensional data format loadable by display-processing software configured to generate a virtual space; compute, based on an environment template, a placement position and an orientation of the object within the virtual space and generate scene configuration information defining the placement of the object; transmit, via the communication interface, the three-dimensional data format of the object data and the scene configuration information to the terminal such that the terminal is enabled to render the virtual space and perform a placement simulation; upon receiving, via the communication interface, an additional prompt sentence from the terminal, analyze the additional prompt sentence in association with the structured information and the three-dimensional object data to extract modification parameters relating to at least one of a shape, a dimension, a color, and a placement position of the object; regenerate or modify, based on the modification parameters, the three-dimensional object data and update the scene configuration information; retransmit the updated scene configuration information to the terminal for iterative design adjustment; and store generated designs in association with identification information, original prompt sentences, and attribute information in a storage resource such that the generated designs are referable and shareable via an information-providing platform. This enables an integrated and computer-centric improvement of the generative design pipeline, in which natural language inputs are consistently transformed into structured internal representations and three-dimensional scene data, iterative refinements are applied as parameter-level modifications rather than full regenerations, and generated designs are stored together with their semantic and generative context, thereby reducing computational redundancy, improving response time, and enhancing reusability and interoperability of three-dimensional content across multiple terminals and applications.

The term “system” refers to a collection of hardware components and software components that cooperate to perform information processing, including at least a server-side processor, one or more terminals, storage resources, and communication interfaces.

The term “processor” refers to one or more hardware processing units, such as a central processing unit or a graphics processing unit, that execute instructions to perform computational operations.

The term “terminal” refers to an information processing apparatus, such as a personal computer, a mobile device, or a head-mounted display device, that provides a user interface, communicates with a server, and renders a virtual space.

The term “server” refers to an information processing apparatus, or a group of such apparatuses, that provides computational services and storage services to one or more terminals via a communication network.

The term “user” refers to a human operator who interacts with the terminal and the system by providing input, including prompt sentences, and by viewing or manipulating output presented in a virtual space.

The term “prompt sentence” refers to a sequence of natural language expressions, typically in text form, that describes a desired object or operation and is provided by a user or generated by the system as input to a generative AI model.

The term “natural language” refers to a human language used for general communication, such as English or another spoken or written language, in contrast to a programming language or a formal notation.

The term “generative artificial intelligence” refers to artificial intelligence technology that learns patterns from training data and generates new data instances, such as images, three-dimensional objects, or design specifications, that are not explicitly present in the training data.

The term “generative AI model” refers to a machine learning model, such as a neural network, configured to generate data including at least one of three-dimensional object data and design information based on input data including prompt sentences and object data.

The term “auxiliary function of generative artificial intelligence” refers to a function in which the generative AI model is used to assist or extend primary processing tasks of the system, such as generating three-dimensional objects or design information in response to prompt sentences.

The term “object data” refers to data representing an object, including at least one of shape information, appearance information, material information, and attribute information associated with a physical or virtual object.

The term “attribute data” refers to data expressing characteristics of an object, including at least one of type, style, color, size, material, usage category, and intended placement environment.

The term “set of object data” refers to a collection of multiple object data items, including attribute data, stored in at least one storage resource for use in training or executing a generative AI model.

The term “storage resource” refers to a hardware storage arrangement, such as a memory device or a storage device, that stores data or instructions, including at least one of a volatile storage and a non-volatile storage.

The term “external storage” refers to a storage device or storage subsystem that is external to a processor core, such as a hard disk drive, a solid state drive, or a network-attached storage.

The term “computation resource” refers to a resource capable of performing arithmetic operations or logical operations, including at least one of a central processing unit, a graphics processing unit, and a specialized accelerator.

The term “natural language processing” refers to a computational technique for analyzing and processing natural language expressions to extract structured information, including at least one of tokenization, parsing, semantic analysis, and entity recognition.

The term “structured information” refers to information represented in a format having predefined fields or relationships, such as a data structure or a record indicating type, style, placement space, and attribute conditions of an object.

The term “object type” refers to a category of an object, such as a piece of furnishing, a wearable article, or another article, identified from a prompt sentence.

The term “style” refers to a design characteristic or aesthetic classification of an object, such as modern, classic, minimalist, or another design category.

The term “target placement space” refers to an intended environment or region in which an object is to be arranged, such as a living space, a commercial space, or a virtual display space.

The term “attribute condition” refers to a condition regarding an attribute of an object, such as a requirement for color, material, size, or functional property, inferred from a prompt sentence.

The term “model-input prompt sentence” refers to a prompt sentence, possibly reformulated or enriched by the system, that is suitable for input to a generative AI model and is derived from structured information.

The term “three-dimensional object data” refers to data representing a three-dimensional object, including at least one of geometric data, such as vertices and faces, and surface data, such as normals and texture coordinates.

The term “parametric design information” refers to information that expresses a design of an object by parameters, such as dimensions, angles, proportions, or material identifiers, which can be used to algorithmically generate three-dimensional geometry.

The term “shape information” refers to information describing the geometric form of an object, including at least one of dimensions, contours, and spatial configuration.

The term “appearance information” refers to information describing the visual aspects of an object, including at least one of color, texture, pattern, reflectivity, and glossiness.

The term “material information” refers to information describing the physical or visual material of an object, such as wood, metal, fabric, or composite, including associated optical or physical properties.

The term “digital form” refers to a representation that is stored or processed as digital data in a storage resource and can be accessed or interpreted by electronic processing equipment.

The term “display-processing software” refers to software capable of rendering or displaying a three-dimensional object and a virtual space using three-dimensional data formats, including at least a three-dimensional rendering engine or a virtual environment engine.

The term “virtual space” refers to a computer-generated environment represented by digital data and capable of visually simulating a three-dimensional scene, including the placement of one or more objects.

The term “environment template” refers to a predefined data structure describing a virtual environment, including at least one of room dimensions, fixed objects, camera settings, and placement constraints, used as a basis for computing placement positions and orientations.

The term “placement position” refers to a location in a coordinate system of a virtual space at which an object is to be arranged.

The term “orientation” refers to an angular disposition or rotation of an object in a virtual space coordinate system.

The term “scene configuration information” refers to information defining composition of a virtual space, including at least object identifiers, placement positions, orientations, scales, lighting conditions, and environmental parameters.

The term “online path” refers to a communication path established via a communication network that enables transmission of data between a server and a terminal.

The term “visual confirmation” refers to a process in which a user visually observes, via a display device, an object or a scene generated by the system to confirm appearance or arrangement.

The term “placement simulation” refers to a process in which a user observes or manipulates an object within a virtual space to simulate placement or arrangement in a physical or conceptual environment.

The term “additional prompt sentence” refers to a prompt sentence provided after a preceding prompt sentence and used to request modification, refinement, or extension of an existing design or scene.

The term “modification parameter” refers to data specifying a change to be applied to a three-dimensional object or a scene, including at least one of a change in shape, dimension, color, or placement position.

The term “iterative design adjustment” refers to a process in which a design or a scene is repeatedly modified in response to a sequence of prompt sentences or user instructions, with each modification based on previous design states.

The term “identification information” refers to data that uniquely or distinctively identifies a generated design, such as an identifier, a hash value, or another unique code.

The term “attribute information” refers to information indicating characteristics of a generated design, including at least type, style, materials, dimensions, and placement context.

The term “information-providing platform” refers to a computing infrastructure, such as a server system or network service, that provides access to stored designs and associated metadata to one or more terminals.

The term “third-party terminal” refers to a terminal that is operated by an entity or user different from an original creator of a design, and that accesses generated designs via the information-providing platform.

The term “procedure information” refers to information describing steps and conditions for producing a physical object, including at least work steps, materials to be used, and dimensional information.

The term “work steps” refers to a sequence of operations or tasks to be performed in order to manufacture or assemble a physical object, such as cutting, joining, finishing, and inspection.

The term “dimensional information” refers to numerical data specifying sizes, distances, or tolerances of parts or features of an object.

The term “furnishing” refers to an article used to equip or arrange a space, such as a piece of furniture or an interior article.

The term “wearable article” refers to an article configured to be worn on a human body, such as a clothing item, accessory, or other personal item.

The term “communication interface” refers to a hardware and software arrangement that enables exchange of data between the server and one or more terminals over a communication network.

In an embodiment, a system includes a server and at least one terminal connected via a communication network. The server includes a processor, a main memory, a non-volatile storage device, and a network interface. The terminal includes a processor, a display, an input device such as a keyboard, a touch panel, or a microphone, and a network interface. The server and the terminal each execute software modules that implement the functions described below.

The server executes an operating system such as a general-purpose server operating system.

The server further executes an application stack that includes at least: a web service framework (for example, a REST or WebSocket server), a natural language processing module, a generative AI model execution module, a three-dimensional data processing module, and a data management module. The server stores object data and model parameters in a storage resource such as a solid-state drive or a network-attached storage device. The server uses a database management system such as a relational database or a key-value store to persist object data, structured information, generated designs, and associated metadata.

The terminal executes an operating system such as a mobile operating system or a desktop operating system, and a client application implemented, for example, using a game engine, a native application framework, or a web rendering engine. The terminal provides a user interface for accepting user input as a prompt sentence in natural language, for transmitting the prompt sentence to the server, and for rendering a virtual space based on three-dimensional object data and scene configuration information sent from the server.

The terminal accepts a prompt sentence such as “I want to place a modern style sofa in my living room.” or “Generate a modern style sofa and place it in a virtual store with wooden flooring and warm lighting.” The terminal displays a text field and optionally a microphone icon. When the user inputs text using the keyboard or touch panel, the terminal stores the text string in a local memory buffer. When the user speaks into the microphone, the terminal sends an audio stream to a speech-to-text component, which may be implemented locally or via a network service. The terminal converts the audio into a prompt sentence in text form and displays the recognized text for confirmation. After the user approves the prompt sentence, the terminal encapsulates the prompt sentence together with context information such as a user identifier and an environment identifier, and transmits this information to the server through the network interface.

The server receives the prompt sentence and stores it temporarily in a request buffer in main memory. The server then applies natural language processing to the prompt sentence. The server uses a language model such as a transformer-based encoder running on the processor or a graphics processing unit. The server tokenizes the prompt sentence, embeds each token into a vector representation, and processes the sequence through multiple attention layers and feed-forward layers. The server thereby obtains contextualized vector representations that encode semantic relations between words such as “sofa,” “modern,” “living room,” and “virtual store.”

The server uses these vector representations to extract structured information. The server identifies an object type, such as a category of furnishing or another article, based on a classifier network trained on labeled data of object names. The server identifies a style, such as modern or classic, by matching tokens and by applying an attention-based classifier. The server identifies a target placement space, such as a living space, a commercial display space, or a virtual showroom, by mapping phrases like “living room,” “virtual store,” or “virtual showroom” into environment categories. The server further extracts attribute conditions such as color preferences, material preferences, and size constraints by pattern matching and by learned attention over descriptive adjectives and noun phrases.

The server converts the extracted results into a structured data object stored in memory. The structured data object may include fields representing type, style, target placement space, and attribute conditions. The server associates the structured data with the original prompt sentence and a request identifier. The server then generates a model-input prompt sentence by reformulating and enriching the original prompt sentence using rule-based templates and an auxiliary language generation model. For example, when the user provides the prompt sentence “Please generate a modern style sofa and place it in a virtual showroom.” the server may produce a model-input prompt sentence such as “Generate a detailed three-dimensional model of a modern style sofa suitable for display in a virtual showroom, including shape, dimensions, materials, and color suitable for contemporary interior design.”

The server uses a generative AI model to generate three-dimensional object data or parametric design information. In one embodiment, the generative AI model is a transformer-based diffusion model trained on pairs of object descriptions and three-dimensional representations. The server stores model parameters as numerical arrays in non-volatile storage and loads them into main memory and a graphics processing unit memory when executing the model. The server passes the model-input prompt sentence through a tokenizer to obtain token IDs and then computes token embeddings. The server processes these embeddings through a stack of transformer blocks, each block including multi-head self-attention sub-layers, layer normalization, and feed-forward sub-layers. The server obtains a latent representation of the desired object in a continuous latent space.

The server then executes a diffusion-based decoder. The server initializes a latent variable as a noise vector or a coarse geometric representation and iteratively denoises this representation based on the latent representation of the prompt. At each iteration, the server applies a neural network that predicts noise components relative to the latent object representation. The server subtracts the predicted noise and updates the latent variable. After a fixed number of iterations, the server decodes the latent variable into either: (i) explicit three-dimensional geometry data including vertices, faces, texture coordinates, and surface normals, or (ii) parametric design information including scalar values for dimensions, angles, curvature parameters, and identifiers of material types and color codes.

The server processes and refines the generated output. When the generative AI model outputs parametric design information, the server applies a geometry generation module implemented using a three-dimensional modeling library. The server uses the parameters to construct primitive shapes such as boxes, cylinders, and surfaces, and composes them into a mesh representing the object. The server computes normals and texture coordinates and ensures that mesh connectivity satisfies predefined quality criteria. When the generative AI model outputs a mesh directly, the server applies mesh cleanup procedures, including merging close vertices, removing degenerate faces, and repairing non-manifold edges. This processing reduces rendering errors and improves numerical stability for subsequent physics calculations.

The server converts the generated three-dimensional object data into a three-dimensional data format that is loadable by display-processing software. The server may use a format such as a three-dimensional scene description file or an exchange format that supports vertices, materials, and texture paths. The server then computes a placement position and an orientation within a virtual space. The server selects an environment template corresponding to the target placement space from a set of stored templates. An environment template defines a coordinate system, a floor plan, fixed objects such as walls and shelves, and a set of placement rules such as minimum clearance distances and orientation preferences relative to a camera.

The server uses the environment template and the dimensions of the generated object to compute a feasible placement. The server uses a collision detection algorithm. The server represents fixed objects and the generated object as bounding volumes such as axis-aligned bounding boxes and use a spatial data structure such as a tree to detect overlaps. The server iteratively adjusts the placement position and orientation until collision constraints and spacing constraints are satisfied. The server records the final placement position, orientation, and scale factor in the scene configuration information. The server assembles the scene configuration information as a data structure that includes one or more object identifiers, transform parameters, lighting configuration references, and environment identifiers. The server transmits the three-dimensional data format of the object and the scene configuration information to the terminal. The server may encapsulate this data as a binary stream or as a structured message. The server sends this data through the network interface using a transport protocol. Because the server performs conversion into a three-dimensional format and computes placement parameters before transmission, the data transmitted to the terminal has a structure that can be rendered directly without further semantic interpretation. This reduces computational overhead at the terminal and reduces overall latency from user prompt to rendered output.

The terminal receives the object data and the scene configuration information. The terminal loads the object data into a local rendering engine. When the terminal uses a three-dimensional engine, the terminal imports the mesh, materials, and textures as assets. The terminal instantiates the object in a local scene graph and assigns the transform parameters indicated by the scene configuration information. The terminal renders the virtual space on the display or in a head-mounted display. The user views the object from multiple viewpoints using input devices to move a camera or to move within the virtual environment. The user may refine the design based on the rendered result. For example, the user may provide an additional prompt sentence such as “Make the sofa slightly smaller and change the color to dark gray fabric.” or “Move the sofa closer to the window.” The terminal accepts this additional prompt sentence and sends it to the server together with an identifier of the existing design or scene. The server receives the additional prompt sentence and associates it with the structured information and three-dimensional object data stored previously for the same design.

The server applies natural language processing again to the additional prompt sentence, but in this case the server uses the existing structured information as context. The server identifies modification directives such as “slightly smaller” and “change the color to dark gray fabric.”

The server maps such directives to modification parameters such as a scale factor less than one for each spatial dimension and a new material identifier for the upholstery. The server uses rules and learned mappings to convert vague expressions such as “slightly” into numerical modifiers based on empirically determined ranges. This non-conventional mapping from qualitative language to quantitative parameters is stored as a rule set or as a regression model trained on data of subjective terms and corresponding numeric values.

The server updates the three-dimensional object data based on the modification parameters. When the modification involves a size change, the server applies a scaling transformation to the vertex coordinates of the mesh or regenerates the mesh using updated parametric design information. When the modification involves a color change, the server replaces material identifiers and texture references in the object data. When the modification involves repositioning, the server recomputes the placement position in the virtual space using the environment template and collision detection. The server does not need to execute the generative AI model from scratch in many cases, because the server reuses the existing structured information and object data and applies parameter-level adjustments. This reduces inference time and computation load on the processor and graphics processing unit, resulting in lower latency for iterative design cycles.

The server generates updated scene configuration information and transmits it to the terminal. The terminal updates the local scene graph accordingly and rerenders the virtual space. The user sees the updated design almost immediately. Because the server stores the original prompt sentences, the structured information, and the resulting object data in association with identification information, the server can reconstruct the sequence of modifications and can reuse prior designs as starting points for new prompts. A third-party terminal can retrieve a stored design together with its metadata via an information-providing platform and display or manipulate the design in a different virtual environment.

The server constructs and maintains specific data structures that improve internal data management. For example, the server uses a design record object that contains: an identifier, the original prompt sentence, the structured information, a reference to the model-input prompt sentence, pointers to the three-dimensional object data and scene configuration information, and a history of modification parameters derived from additional prompt sentences. The server indexes these records by object type, style, and environment category. This indexing allows the server to quickly locate relevant prior designs and to feed them as reference examples or initialization states to the generative AI model, which improves convergence and stability of the model during inference.

The server trains the generative AI model using a dataset of object descriptions and three-dimensional representations. During training, the server stores training examples in the storage resource and loads them in batches into memory and graphics processing unit memory. The server defines a loss function that measures the difference between predicted object representations and ground-truth representations. When the model outputs latent geometries, the server may compute a loss based on distances between corresponding vertices or between sampled points on surfaces. When the model outputs parametric design information, the server computes a loss over predicted parameter values. The server may also include regularization terms for smoothness or plausibility of geometry, and terms that encourage alignment between text embeddings and object embeddings in a shared space. The server uses an optimization algorithm such as a variant of stochastic gradient descent. The server computes gradients of the loss function with respect to model parameters by backpropagation, using automatic differentiation. The server updates the model parameters at each iteration based on learning rates and momentum parameters. The server may use data augmentation techniques such as random rotations, scaling, and variations in lighting conditions to generate additional synthetic training examples. These techniques increase robustness of the generative AI model and reduce overfitting. Because the model parameters and training procedures are executed in a systematically defined architecture, the server improves prediction accuracy for three-dimensional object generation and reduces variance in generated designs.

The server, by coordinating the natural language processing module, the generative AI model execution module, the three-dimensional data processing module, and the scene configuration module, improves computer technology beyond a simple automation of human design tasks. First, the server reduces redundant computation by associating additional prompt sentences with previously stored structured information and object data, and by applying parameter-level modification rather than recomputing entire designs. This yields faster response and lower utilization of processing resources. Second, the server enforces a unified internal representation that maps prompt sentences to structured information and three-dimensional object data. This mapping reduces conversion errors and inconsistent interpretation of user intent, thereby increasing the precision and repeatability of design generation.

Third, the server integrates collision-aware placement computation with generative design, which allows the server to guarantee that generated objects can be placed in virtual spaces without manual adjustment. The server uses non-trivial geometric algorithms and spatial indexing structures that provide technically grounded improvements over manual or ad-hoc placement methods. Fourth, the server records prompt sentences, structured information, models' inputs, and outputs as linked data structures. This enables downstream systems to analyze and reuse the design pipeline and to incorporate prior designs as part of their own processing. As a result, the server improves data management for three-dimensional content and reduces the need for separate manually curated libraries.

In another embodiment, the server uses a different architecture for the generative AI model, such as a variational autoencoder combined with a text encoder. The server encodes three-dimensional object data into a latent space and trains a decoder to reconstruct geometry from latent codes. The server then trains a text encoder to map prompt sentences into the same latent space. During inference, the server maps a prompt sentence into a latent vector and decodes it into object geometry. In yet another embodiment, the server combines rule-based constraints with generative outputs. The server may enforce structural rules such as minimum thickness for structural stability or maximum width for passage through standard openings. The server merges such constraints with generated parametric design information to produce geometries that meet practical requirements, which connects virtual design with physical manufacture.

In another embodiment, the server generates procedure information for manufacturing or assembling physical objects. When the generative AI model outputs parametric design information, the server computes cutting patterns, joint locations, and assembly sequences. The server decomposes the object into parts, computes dimensions for each part, and orders parts based on assembly dependencies. The server then describes work steps such as “cut a rectangular board of specified dimensions,” “attach legs using specified fasteners,” and “apply a specified surface finish.” The server transmits this procedure information to the terminal, which displays step-by-step instructions. This use case demonstrates a link between the virtual design pipeline and machine-assisted physical fabrication.

In still another embodiment, the server extends the object data set beyond furnishing to include wearable articles and other articles. The server stores attribute data specific to wearable articles, such as size charts, fabric types, and fit categories. When the user provides a prompt sentence such as “Generate a set of dining chairs with Scandinavian design.” or “Design a minimalist jacket with a modern style.” the server applies the same natural language processing and generative pipeline but with object types and style constraints specific to these categories. The server can simulate placement of such objects in a virtual environment or on a virtual avatar, depending on the target placement space.

The system, by implementing these embodiments, provides a technical framework in which the server and the terminal cooperate to transform prompt sentences into structured information, into generative AI model inputs, into three-dimensional object data, and into collision-aware virtual scenes, and to iteratively refine these outputs using additional prompt sentences. The technical structure of this transformation, including specific data structures, model architectures, and processing flows, yields concrete improvements in computation efficiency, precision of design representation, and effectiveness of virtual simulation, and thus constitutes more than an abstract automation of conceptual design.

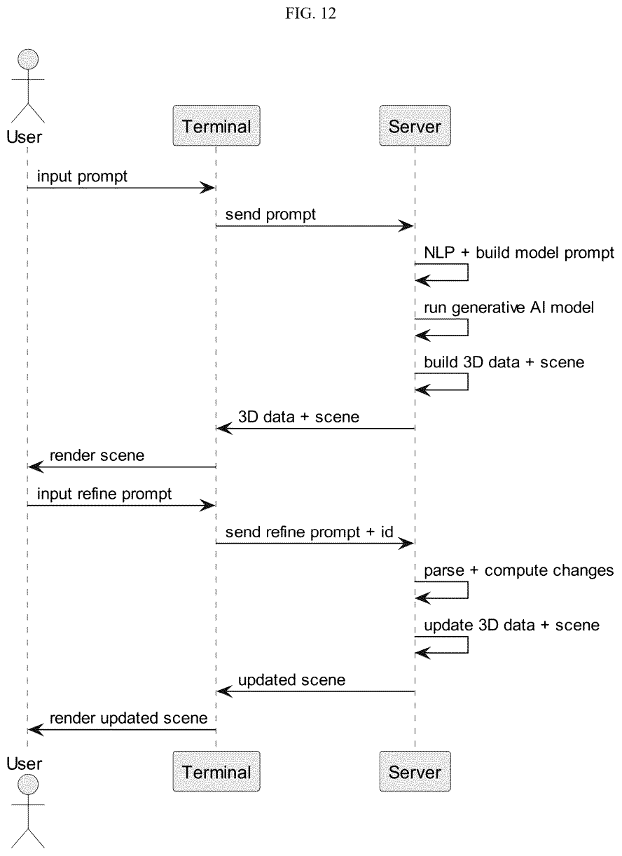

The following describes the processing flow using FIG. 12.

### Step 1:

User uses the terminal to input an initial prompt sentence.

User operates a keyboard, touch panel, or microphone on the terminal to provide a natural-language description such as “I want to place a modern style sofa in my living room.” or “Generate a modern style sofa and place it in a virtual store with wooden flooring and warm lighting.” As input, the terminal receives raw keystrokes or an audio signal. The terminal converts the input into a text string by aggregating keystrokes or by applying speech-to-text processing. The terminal outputs a confirmed prompt sentence string and displays it on the screen for user verification.

### Step 2:

Terminal transmits the prompt sentence and context to the server.

Terminal uses the network interface to package the prompt sentence together with context information, such as a user identifier, a current scene identifier, and optional environment parameters, into a structured message. As input, the terminal uses the confirmed prompt sentence string and locally stored context variables. The terminal performs data serialization (for example, into a structured message body) and sends the serialized message over a network protocol to the server. The terminal outputs a network request containing the prompt sentence and context as digital data.

### Step 3:

Server receives the network request and buffers the prompt sentence.

Server uses the network interface to accept the incoming request from the terminal. As input, the server receives a byte stream that encodes the structured message. The server parses the byte stream according to the communication protocol, validates fields such as the user identifier and the presence of the prompt sentence, and stores the prompt sentence and context in a request buffer in main memory. The server outputs a normalized internal representation of the request, including the raw prompt sentence string and associated context objects.

### Step 4:

Server applies natural language processing to extract structured information.

Server invokes a natural language processing module on the prompt sentence contained in the internal representation. As input, the server uses the raw prompt sentence string. The server tokenizes the string into tokens, maps each token to an embedding vector, and processes the sequence through one or more language model layers to compute contextual embeddings. The server then applies classification and parsing logic to identify an object type (for example, furnishing, seating), a style (for example, modern), a target placement space (for example, living room, virtual store), and attribute conditions (for example, color, material, size adjectives). The server combines these derived values into a structured information object with fields for type, style, target placement space, and attributes. The server outputs this structured information object and links it to the original prompt sentence.

### Step 5:

Server generates a model-input prompt sentence from the structured information.

Server uses the structured information and the original prompt sentence as input. The server applies rule-based templates and, optionally, an auxiliary language generation model to enrich and normalize the user's expression. The server performs string concatenation, insertion of default parameters (such as standard dimensions for the identified object type), and rephrasing to match the generative AI model's expected input style. The server outputs a model-input prompt sentence that explicitly describes required geometry, appearance, and placement context, suitable as an input to the generative AI model.

### Step 6:

Server retrieves relevant object data and prepares feature inputs.

Server accesses a storage resource to retrieve object data records associated with the object type and style identified in the structured information. As input, the server uses the type, style, and attribute fields, and issues database queries to obtain attribute data such as typical dimensions, material options, and existing style exemplars. The server performs data processing that includes filtering records by style tags, aggregating size ranges, and encoding categorical values into numerical feature vectors using pre-computed embeddings or lookup tables. The server outputs a feature input bundle that contains object type embeddings, style embeddings, candidate materials, and dimensional priors to be used alongside the model-input prompt sentence.

### Step 7:

Server executes the generative AI model to produce object representation.

Server feeds the model-input prompt sentence and the feature input bundle into a generative AI model running on a processor or a graphics processing unit. As input, the server converts the model-input prompt sentence to token IDs, maps them to embeddings, and combines them with the numerical feature vectors. The server performs machine-learning computations, including matrix multiplications, attention operations, activation functions, and iterative denoising if a diffusion process is used. The server calculates a latent representation of the object consistent with the prompt and features, and decodes this latent representation into either three-dimensional object data (vertices, faces, UV coordinates, normals) or parametric design information (dimensions, angles, material identifiers, color codes). The server outputs a generated object representation that encodes shape information, appearance information, and material information.

### Step 8:

Server converts and refines the generated object representation into a three-dimensional data format.

Server uses the generated object representation as input. If the representation is parametric, the server runs a geometry generation module that uses the parameters to construct and tessellate three-dimensional primitives into a mesh. If the representation is a raw mesh, the server applies mesh processing operations, such as vertex merging, normal recalculation, and removal of degenerate faces. The server then converts the cleaned mesh into a standard three-dimensional data format that is compatible with display-processing software, assigning material references and texture coordinate mappings according to the material information. The server outputs a three-dimensional object file or in-memory structure in a standardized format.

### Step 9:

Server computes placement position and orientation within a virtual space.

Server uses the three-dimensional object data, the structured information, and an environment template as input. The server reads environment dimensions, fixed object positions, and placement rules from the template corresponding to the target placement space. The server computes initial placement coordinates based on high-level rules (for example, centering in front of a primary wall or within a specific region of a virtual store) and then refines the coordinates using collision detection algorithms and spatial constraints. The server performs geometric computations such as bounding volume intersection tests and distance calculations to ensure that the object does not overlap existing elements and respects minimum clearance constraints. The server outputs a placement transform that includes position, orientation, and scale parameters for the object in the virtual space.

### Step 10:

Server assembles scene configuration information.

Server combines the placement transform with identifiers for the three-dimensional object data and environment template. As input, the server uses the object identifier, the placement transform, and the environment parameters. The server constructs a scene configuration object or file describing which objects are present, their transforms, and any scene-level metadata such as lighting presets or camera defaults. The server performs data structuring by assigning unique identifiers, organizing objects into scene graph relationships if needed, and packing relevant parameters into a serializable form. The server outputs the scene configuration information ready for transmission to the terminal.

### Step 11:

Server transmits the three-dimensional object data and scene configuration to the terminal.

Server uses the standardized three-dimensional object data and the scene configuration information as input. The server serializes these structures into one or more message payloads and may compress them to reduce network bandwidth. The server sends these payloads via the network interface to the terminal using a network protocol. The server outputs a stream of data packets that, when received by the terminal, contain all information needed to reconstruct the object and the scene for visualization.

### Step 12:

Terminal receives and loads the three-dimensional object data and scene configuration.

Terminal uses the incoming data packets from the server as input. The terminal reassembles the packets into the original payloads, decompresses them if necessary, and parses the three-dimensional object file and scene configuration information. The terminal loads the object into a local rendering engine, creating a mesh object with associated material definitions, and inserts it into a scene graph. The terminal applies the placement transform specified in the scene configuration, assigning position, orientation, and scale to the object. The terminal outputs an in-memory representation of the virtual scene ready for rendering.

### Step 13:

Terminal renders the virtual space and presents it to the user.

Terminal uses the in-memory scene graph and rendering engine as input. The terminal performs graphics computations, including transformation of vertices according to the placement transform, lighting calculations, shading, and rasterization, using a graphics processing unit or a hardware renderer. The terminal generates image frames representing the virtual space and displays them on a screen or within a head-mounted display. The terminal outputs a visual presentation in which the user can observe the generated object within the chosen virtual environment.

### Step 14:

User evaluates the rendered design and decides whether to refine it.

User uses the display output and, optionally, interaction mechanisms such as touch gestures, mouse movements, or controller input to view the generated scene from different angles. As input, the user receives visual feedback showing the object's size, color, and position relative to the environment. Based on this feedback, the user mentally evaluates whether the design matches their intent. The user outputs either an acceptance decision or a desire for modification, which is expressed by further interaction with the terminal.

### Step 15:

User inputs an additional prompt sentence for refinement.

User, when requesting changes, enters a new natural-language description such as “Make the sofa slightly smaller and change the color to dark gray fabric.” or “Move the sofa closer to the window.” As input, the terminal again receives raw keystrokes or audio. The terminal converts this input into a text string, confirms it with the user, and associates it with an identifier of the current design or scene. The terminal outputs an additional prompt sentence paired with a design identifier, which it then transmits to the server as a new request.

### Step 16:

Server analyzes the additional prompt sentence in the context of existing data.

Server receives the new request, which includes the additional prompt sentence and the design identifier. As input, the server retrieves the previously stored structured information and three-dimensional object data corresponding to the design identifier from storage. The server applies natural language processing to the additional prompt sentence to detect modification instructions related to shape, size, color, or position. The server compares extracted terms with existing attribute values in the structured information and computes modification parameters such as a new scale factor, a new material identifier, or a new offset in placement coordinates. The server outputs a set of modification parameters that describe how the current object and scene should be adjusted.

Server modifies or regenerates the three-dimensional object data using the modification parameters.

Server uses the existing three-dimensional object data and the modification parameters as input. For size changes, the server performs geometric transformations by multiplying vertex coordinates by scale factors; for color changes, the server replaces material entries or texture references in the object data; for positional changes, the server alters the placement transform and re-evaluates collision constraints using the environment template. If a modification requires structural changes beyond parameter adjustment, the server may re-invoke the generative AI model with an updated model-input prompt sentence constructed from the original structured information and the additional prompt sentence. The server outputs updated three-dimensional object data and, when applicable, an updated placement transform.

### Step 18:

Server updates scene configuration information and returns it to the terminal.

Server uses the updated object data and placement transform as input. The server revises the scene configuration object, replacing previous transform values and, if needed, updating object identifiers or material references. The server serializes the updated configuration and, if the geometry changed significantly, transmits updated object data as well. The server performs data packaging and sends the new payload to the terminal over the network. The server outputs revised scene configuration information that reflects the user's requested adjustments.

### Step 19:

Terminal applies updates and re-renders the adjusted virtual space.

Terminal receives the revised configuration and, optionally, updated object data from the server as input. The terminal updates the local scene graph by applying new transforms or loading new geometry, and invalidates previous render caches if necessary. The terminal invokes the rendering engine again to compute new image frames reflecting the changes in size, color, or position. The terminal outputs an updated visual presentation of the virtual space to the user, completing one refinement cycle and allowing additional iterations as desired.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented design support systems for furnishings and other articles typically require the user to possess specialized design knowledge or to manually translate contextual conditions, such as room size, shape, and color scheme, into highly structured parameter sets. As a result, ordinary users who can only express their needs in natural language are unable to fully exploit such systems. Furthermore, even when a generative AI model is employed, existing approaches often pass user text directly to the model without systematic normalization, template-based prompt generation, or post-processing, which leads to unstable output quality, inconsistent units or dimensions, and missing steps in assembly instructions. This degrades the reliability and usability of the resulting design data.

From a computer technology standpoint, there is also no standardized mechanism in the prior art for: (i) converting heterogeneous, noisy user inputs (natural language and numerical values) into a machine-friendly internal representation; (ii) dynamically generating a prompt sentence that reliably conditions a generative AI model toward producing structured, fabrication-ready design data; and (iii) automatically parsing, validating, and re-structuring the model output into explanation information and visualization information optimized for display on a terminal device. As a result, servers executing generative-design workflows waste processing resources on ad hoc parsing, generate incompatible formats for different front-ends, and require extensive manual intervention to refine AI-generated content. Accordingly, there is a need for an improved computer-implemented system, and in particular an improved server-side processing architecture, that: (a) acquires space-related information and user preference conditions in a flexible manner from a terminal device; (b) normalizes such input into internal representation data; (c) generates, based on the internal representation data, a well-structured prompt sentence for a generative AI model of a generative artificial intelligence; (d) invokes the generative AI model and obtains design data including dimension information, component information, material information, and assembly procedure information; and (e) automatically converts such design data into structured data, explanation information, and visualization information suitable for direct use by the user. There is also a need to improve the way in which design data, internal representation data, and prompt sentences are stored and shared so that subsequent sessions and users can re-use previously generated designs without repeating the full generative process, thereby improving computational efficiency and the technical operation of the system as a whole.

The specific processing by the specific processing unit 290 of the data processing device 12 in Example 2 is realized by the following means.

The present invention provides a server comprising a processor and a memory storing instructions that, when executed by the processor, cause the processor to acquire, via a terminal device, space-related information and preference conditions regarding a target object input by a user in natural language or as numerical values, to analyze the input data including the space-related information and the preference conditions and normalize the input data into internal representation data, to generate, based on the internal representation data, a prompt sentence described in natural language that specifies instructions to a generative AI model of a generative artificial intelligence by dynamically filling a template, to input the prompt sentence to the generative AI model and invoke the generative AI model via an external information processing resource or an internal information processing resource so as to obtain design data including design information of a furnishing or an article, to analyze the design data obtained from the generative AI model and extract dimension information, component information, material information, and assembly procedure information and convert such extracted information into structured data, to generate, based on the structured data, explanation information and visualization information in a format understandable to the user, to transmit, via a network, the explanation information and the visualization information to the terminal device for display so as to assist the user in manually producing the furnishing or the article adapted to the space, and to store the internal representation data, the prompt sentence, and the design data in a storage medium to enable sharing or re-use of the design data in an online environment. This enables improvement of the operation of the computer system itself by providing a technically structured pipeline that converts heterogeneous user input into normalized internal representation data, reliably conditions a generative AI model via a dynamically generated prompt sentence, and automatically transforms model output into validated, structured design data and presentation-ready explanation and visualization information, thereby reducing processing overhead, increasing consistency and quality of generated designs, and allowing efficient sharing and re-use of design data across multiple sessions and users.

The term “processor” refers to a hardware computation unit, or a set of hardware computation units, configured to execute machine-readable instructions, including a central processing unit, a graphics processing unit, or any combination thereof.

The term “terminal device” refers to an information processing apparatus operated by a user, such as a personal computer, a tablet device, a smartphone, or any other electronic device capable of inputting data, communicating over a network, and displaying information.

The term “space-related information” refers to information describing a physical or virtual environment, including at least one of size, shape, color, arrangement, or style of a room, area, or other space in which a furnishing, an article, or a wearable object is to be placed or used.

The term “preference conditions” refers to user-specified requirements or constraints regarding a target object, including at least one of type, style, function, size preference, color preference, or material preference.

The term “target object” refers to any object for which a design is to be generated, including at least a furnishing, an article, or a wearable object.

The term “input data” refers to data acquired from the terminal device and provided by the user, including at least the space-related information and the preference conditions, and optionally including additional contextual or user profile information.

The term “internal representation data” refers to normalized and structured data generated by the processor based on the input data, the internal representation data being in a machine-friendly format suitable for subsequent prompt generation and processing.

The term “generative artificial intelligence” refers to a computational system including at least one generative AI model that is configured to generate output data, such as text, images, or structured information, in response to an input sequence.

The term “generative AI model” refers to a learned computational model of a generative artificial intelligence, such as a language model or a multimodal model, configured to produce design data based on a prompt sentence.

The term “prompt sentence” refers to a natural-language text generated based on the internal representation data and describing instructions or conditions that condition the generative AI model to generate design data satisfying the space-related information and the preference conditions.

The term “template” refers to a predefined text pattern or structure including placeholders, the placeholders being filled with values derived from the internal representation data to form the prompt sentence.

The term “external information processing resource” refers to a computation resource that is located outside the server and is accessible via a communication network, including at least a remote server, a cloud computing resource, or a remote AI inference service.

The term “internal information processing resource” refers to a computation resource located within or directly controlled by the server, including at least a local processing unit, local memory, or a locally deployed AI inference engine.

The term “design data” refers to data generated by the generative AI model in response to the prompt sentence, the design data including at least design information of a furnishing, an article, or a wearable object.

The term “design information” refers to descriptive or structural information concerning a target object, including at least dimension information, component information, material information, and assembly procedure information.

The term “furnishing” refers to an object intended to be placed in a space for use or decoration, including at least furniture such as tables, chairs, shelves, cabinets, or other interior items.

The term “article” refers to a manufactured object other than a furnishing or a wearable object, including at least appliances, containers, fixtures, or functional items used in a space.

The term “dimension information” refers to numerical data indicating sizes or spatial extents of parts or whole structures of a target object, including at least lengths, widths, heights, thicknesses, and associated units.

The term “component information” refers to data describing individual parts constituting a target object, including at least part names, quantities, dimensions, and relationships among parts.

The term “material information” refers to data indicating types and properties of materials to be used in constructing a target object, including at least material categories, grades, and optional finishing conditions.

The term “assembly procedure information” refers to data describing ordered operations for constructing a target object, including at least stepwise instructions, operation sequences, and references to components and tools.

The term “structured data” refers to data arranged according to a defined schema or format, such as a list, a table, or a hierarchical object, which explicitly represents at least the dimension information, component information, material information, and assembly procedure information.

The term “explanation information” refers to human-readable text or equivalent content generated from the structured data, including at least a component list, a required tool list, and stepwise work instructions.

The term “visualization information” refers to data representing a visual depiction of at least a part of a target object or its relation to a space, including at least two-dimensional or three-dimensional graphic data.

The term “graphic data” refers to data for rendering an image or geometric representation, including at least vector data, raster data, or three-dimensional model data.

The term “network” refers to a communication infrastructure that enables data transmission between the server and the terminal device, including at least a local area network, a wide area network, or a public network.

The term “storage medium” refers to any non-transitory medium capable of storing data or instructions, including at least semiconductor memory, magnetic storage, optical storage, or other computer-readable media.

The term “online environment” refers to an environment in which the server and one or more terminal devices are interconnected via the network, such that the design data, internal representation data, or prompt sentences can be shared, accessed, or re-used.

The term “wearable object” refers to an object intended to be worn by a human body, including at least clothing, accessories, footwear, or similar items.

The term “arrangement conditions” refers to constraints or preferences related to placing an object in a physical or virtual space, including at least position, orientation, spacing, or relation to other objects.

The term “decoration conditions” refers to constraints or preferences regarding visual appearance of an object or a space, including at least color, pattern, style, or ornamentation.

The term “living space” refers to a physical environment in which a person resides or spends time, including at least a room, a dwelling, or a functional area within a building.

The term “virtual space” refers to a computer-generated environment or scene presented on a display device or through an immersive interface, in which at least a representation of a target object or a wearable object can be arranged or simulated.

The term “simulation information” refers to data describing or enabling the representation of how a target object or a wearable object appears, is arranged, or is worn in a living space or a virtual space, including at least positional, orientational, or contextual data.

In one embodiment, a server cooperates with one or more terminal devices operated by a user to generate, refine, and deliver design data for furnishings, articles, and wearable objects based on a generative AI model. The server executes a program stored in a non-transitory storage medium. The program causes the server to perform specific data transformations and control operations using defined hardware and software components.

### A. Overall Hardware and Software Configuration

The server operates on a general-purpose computing platform such as an x86-based or ARM-based rack-mounted machine or a virtual machine instance. The server uses an operating system such as a general-purpose server operating system. The server executes a backend application implemented, for example, on a web framework such as a scripting-language based framework, a Java-based framework, or a JavaScript-based framework. The server accesses a relational database management system, such as a structured query language database, through an object-relational mapping library. The server communicates with a generative AI model in two possible configurations. In a first configuration, the server accesses a remote model endpoint over a network using an HTTPS client library. In a second configuration, the server executes a local inference engine for a neural network model using a machine learning framework such as a tensor-based computation framework. In both configurations, the generative AI model is implemented as a transformer-based neural network with multiple self-attention layers, feed-forward layers, and layer-normalization modules, trained on a large corpus of text and design-related data. The terminal operates as a user-facing computing apparatus, such as a personal computer, a tablet device, or a smartphone. The terminal executes a web browser or a native application that renders a graphical user interface for input and display. The terminal communicates with the server via a network using standard communication protocols.

The user interacts with the terminal by means of a pointing device, a touchscreen, or a keyboard, and provides input data including space-related information and preference conditions.

### B. Data Structures and Internal Representation

The server uses explicit data structures to manage the design workflow. The server stores user input as an input data object containing at least fields for space-related information and preference conditions. For example, the server uses an internal object having fields such as:
room_length, room_width, and room_height;
room_shape;
wall_color and floor_color;
furniture_type or wearable_type;
style;
tool_set;
skill_level.

The server converts the input data object into internal representation data. The internal representation data uses normalized units and controlled vocabularies. The server, for instance, converts all length values into a base unit such as millimeters, and maps style descriptors into standardized categories such as “modern,” “classic,” or “minimal.” The server uses a lookup table stored in the database to map free-form text into these categories. This mapping reduces ambiguity and improves the conditioning of the generative AI model. The server maintains the internal representation data in a structured format, such as a key-value map or a typed record. This structure is used to generate a prompt sentence and to perform downstream consistency checks.

### C. Prompt Sentence Generation and Examples

The server uses a prompt generation module that constructs a prompt sentence from the internal representation data. The server uses a template-based approach. The template is stored as a string with placeholders corresponding to internal fields. The server fills the placeholders using the normalized values from the internal representation data.

For example, when the user specifies a rectangular room of 3 m by 4 m, white walls, dark brown flooring, a modern dining table, and beginner skill level, the server generates a prompt sentence such as:

“Design a DIY modern dining table suitable for a 3 m by 4 m rectangular room with white walls and dark brown flooring. Provide approximate dimensions, a parts list, recommended materials, and step-by-step assembly instructions. Assume the user is a beginner and has the following tools: hand saw, drill, screwdriver.”

In another example, when the user specifies a bookshelf with Scandinavian style, the server generates a prompt sentence such as:

“Design a DIY Scandinavian bookshelf suitable for a 3 m by 4 m rectangular room with white walls and dark brown flooring. Provide overall dimensions, a detailed parts list with measurements in millimeters, recommended wood types and hardware, and clear, numbered step-by-step assembly instructions. Assume the user is a beginner and has only basic tools: hand saw, drill, screwdriver, and hammer. Make sure the design is stable and safe for storing books.”

In yet another example, when the user specifies a wearable object for a virtual space, the server generates a prompt sentence such as:

“Design a wearable jacket suitable for use in a virtual living room with light gray walls and natural wood flooring. Provide style details, material choices, and size guidelines, and describe how the jacket appears when worn in the virtual space. Include an explanation of how the jacket coordinates with the room colors and furniture style.”

The server applies non-trivial rules when constructing these prompt sentences. The server selects tool sets based on skill level and furniture type, adds unit constraints such as “measurements in millimeters,” and includes explicit safety or stability requirements for objects like bookshelves. These rules are implemented in the server as rule tables or decision trees rather than simple string concatenation. This structured prompt generation reduces variability and leads to designs with more predictable structure and content.

### D. Generative AI Model Architecture and Training

The server uses a generative AI model implemented as a transformer-based language model.

The generative AI model includes an embedding layer that maps tokens to vector representations, a stack of self-attention blocks, and a final linear layer that outputs a probability distribution over possible next tokens.

The generative AI model is trained by minimizing a cross-entropy loss function over large corpora of text. For design-specific tasks, the model is optionally fine-tuned using a corpus of design descriptions, furniture manuals, assembly instructions, and structured design specifications. The server or an associated training system uses gradient-based optimization to update model parameters. The training procedure includes backpropagation, adaptive learning rate methods such as Adam, and regularization techniques such as dropout. Data augmentation can be performed by paraphrasing instructions or by randomizing units and converting between metric and imperial systems, so that the model becomes robust to different unit conventions.

The server controls inference parameters such as temperature, maximum token count, and top-p sampling to balance creativity and determinism. For example, the server uses a low temperature and constrained maximum length when generating parts lists and dimensions, thereby improving numerical consistency and reducing hallucinated components. The server uses distinct decoding settings for explanatory text versus structured sections by inserting special section markers into the prompt sentence and adjusting sampling settings when such markers are encountered.

Because of these architectural and training choices, the generative AI model produces output that is more suitable for programmatic parsing and validation than a generic conversational model. The server leverages this property to achieve a technical improvement in the reliability and machine-readability of generated design data.

### E. Analysis, Normalization, and Validation of Design Data

The server receives the raw text output from the generative AI model and converts it into structured design data. The server uses a combination of pattern-based parsing and schema-driven extraction. The server employs specialized parsers that search for headings such as “Dimensions,” “Materials,” “Parts List,” and “Assembly Steps,” and split the text accordingly. The server then applies regular expressions to extract numeric values, measurement units, part names, and quantities.

The server converts the extracted values into a normalized unit system. When the generative AI model outputs values like “36 inches” or “3 feet,” the server converts those values into millimeters using predetermined conversion factors. The server stores the normalized dimension information in a structured data object containing fields for length, width, height, thickness, unit type, and tolerance (if specified).

The server executes consistency checks that are not easily performed by a human in real time. The server verifies that all referenced parts in the assembly steps appear in the parts list, and that quantities are sufficient for the described steps. The server checks for geometric plausibility, for example, that table legs are not longer than a threshold relative to the table height, and that negative or zero dimensions are not present. The server logs inconsistencies for debugging and may adjust or annotate instructions to remove contradictions, such as by flagging impossible dimensions in the explanation information.

By implementing these automatic checks and conversions, the server reduces errors and inconsistencies that would otherwise arise when directly using generative AI output. This produces a technical effect in the form of lower error rates, fewer invalid designs, and reduced need for manual post-editing.

### F. Generation of Explanation Information and Visualization Information

The server transforms the structured design data into explanation information and visualization information optimized for display on the terminal. The server generates explanation information as text sections, including a component list, required tool list, and stepwise work instructions. The server orders the steps logically, ensures that each step has a clear action verb, and inserts references to specific parts and dimensions.

The server generates visualization information as two-dimensional or three-dimensional graphic data. In one embodiment, the server uses a geometry module to compute object outlines based on dimension information and component relationships. The server constructs simple parametric representations of boards, legs, and panels in a local coordinate system. The server then encodes these as vector drawing commands or as polygon meshes. In a two-dimensional case, the server generates top-view and front-view line drawings. In a three-dimensional case, the server generates mesh data that can be rendered by a graphics engine on the terminal.

The server uses the structured data to control visual scaling, aspect ratios, and alignment, so that the diagrams accurately reflect the normalized dimensions. This ensures that visualizations are consistent with the text description and can be used for practical measurement and fabrication.

### G. Technical Effects Beyond Mere Automation

The server improves computer technology by introducing a pipeline that is optimized for generative design tasks and that yields machine-readable, verifiable design data. Traditional systems either rely on manual CAD workflows or on direct free-form generation by AI without structured validation. The present system provides the following technical effects:

### 1. Improved Processing Speed and Efficiency:

The server reduces the number of iterative API calls and user corrections by generating a more precise prompt sentence and performing automatic validation and normalization.

Because the prompt sentence is derived from a normalized internal representation and includes specific instructions (for example, unit constraints and safety requirements), the generative AI model is less likely to produce unusable output, thereby reducing network usage and CPU/GPU time for repeated inference.

### 2. Increased Accuracy and Reduced Errors:

The server checks numerical values for plausibility and consistency, converts units, and ensures completeness of parts lists relative to assembly steps. These automated checks significantly reduce dimensional errors and missing components, improving the technical quality of design data beyond what a human user could reliably achieve without assistance.

### 3. Improved Data Management and Reuse:

The server stores internal representation data, prompt sentences, and design data in a storage medium with defined schemas. The server can use these stored items to regenerate visualizations, to modify designs, or to generate variant designs (for example, scaling a table from 4 seats to 6 seats) without reconstructing the entire pipeline from scratch. This structured storage improves memory usage and retrieval speed and enables model-agnostic reuse of design data.

### 4. Reduced Communication Load and Optimized Network Usage:

The server reduces redundant transmission by sending compact structured data and visualization instructions to the terminal, rather than raw AI outputs or full-resolution images.

The terminal reconstructs the final user interface from this compact representation. This architecture allows the server to serve multiple terminals with lower bandwidth usage.

### 5. Non-Conventional AI Usage:

The server does not merely replace a human designer with AI. The server uses the generative AI model in combination with specific normalization, rule-based template filling, and structured post-processing. The pipeline applies programmatic rules and schemas that are not part of conventional human practice. The combination of transformer-based text generation with database-backed normalization, structured parsing, and geometry-aware visualization is a non-traditional, machine-centric method that exploits the strengths of both symbolic and neural processing.

### H. Alternative Embodiments and Variations

The server can support alternative generative AI models beyond a text-only model. In one variation, the server uses a multimodal model that produces both textual design data and low-resolution schematic images. The server still parses the textual part into structured data and uses the schematic images as optional references, while the main visualization is regenerated from normalized geometric parameters, thereby ensuring consistency.

In another variation, the server integrates a secondary verification model. The server feeds the structured design data into a smaller classifier model trained to predict whether a design meets basic safety or usability criteria (for example, minimum shelf depth for books or minimum leg thickness for a given height). If the verification model indicates a failure, the server annotates the explanation information with warnings or, in some cases, modifies the prompt sentence to request a revised design.

In yet another embodiment, the server supports wearable objects in virtual spaces. The server maps clothing sizes and shape parameters to avatar body dimensions and to scene scale parameters. The server generates prompt sentences that explicitly describe these dimensions, and the generative AI model outputs style and fit recommendations. The server then produces simulation information that can be rendered by a 3D engine on the terminal.

In all these embodiments, the server maintains the same core architecture: acquisition of heterogeneous user input at the terminal, transformation of the input into normalized internal representation data, template-based and rule-driven generation of a prompt sentence, controlled invocation of a generative AI model, structured parsing and validation of the output, generation of explanation information and visualization information, and efficient storage and reuse of all intermediate and final data. The user remains responsible only for specifying high-level requirements and for physically fabricating the object according to the displayed instructions. The technical workload of converting high-level requirements into reliable design data is performed in a specialized manner by the server, resulting in an improvement to the functioning of the computer system itself rather than a mere automation of human mental processes.

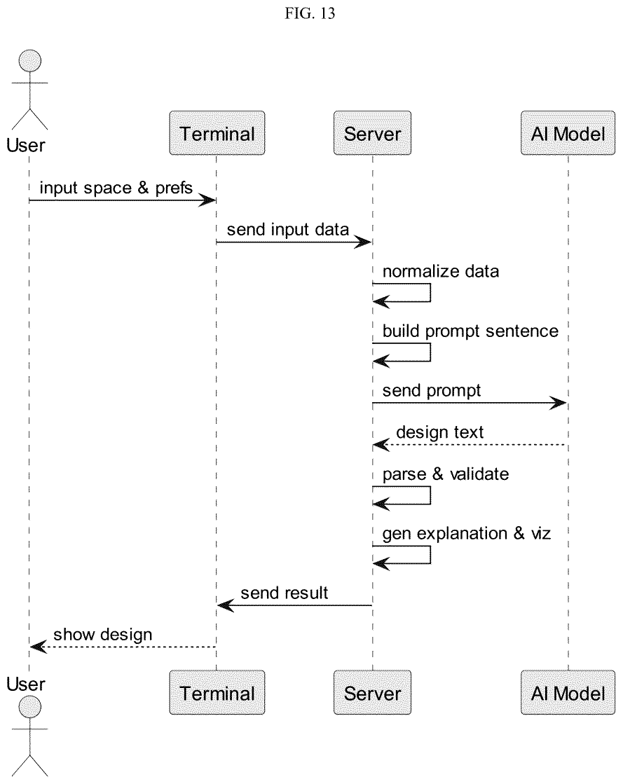

The following describes the processing flow using FIG. 13.

### Step 1:

The user operates the terminal and opens a design support application or web page.

The terminal displays input fields for space-related information and preference conditions, including room size, room shape, wall color, floor color, target object type, desired style, tool availability, and user skill level.

Input: touch or keyboard operations by the user (text values, numeric values, menu selections).

The terminal converts the user's actions into internal form data, checks that mandatory fields are filled and that numeric values (such as room length and width) are valid numbers greater than zero, and rejects obviously invalid entries.

Output: a validated set of input values held in the terminal's local memory.

### Step 2:

The terminal constructs an input data object from the validated values.

Input: the validated set of input values from Step 1.

The terminal maps each form field to a key in a structured object (for example, “room_length”, “room_width”, “room_shape”, “wall_color”, “floor_color”, “furniture_type”, “style”, “tool_set”, “skill_level”) and serializes this object into a text-based representation such as JSON. The terminal adds metadata such as a timestamp or session identifier.

Output: a serialized input data payload ready for transmission.

### Step 3:

The terminal transmits the input data payload to the server over a network.

Input: the serialized input data payload constructed in Step 2.

The terminal opens an HTTPS connection to a predefined endpoint of the server and sends an HTTP request that includes the payload in its body. The terminal manages encryption, error handling, and possible retransmission if the connection fails.

Output: a network message containing the user's input data delivered to the server.

### Step 4:

The server receives and parses the input data payload.

Input: the network message sent by the terminal in Step 3.

The server's web framework extracts the body of the HTTP request and passes it to a parsing routine. The server decodes the serialized representation into an internal data structure, such as a key-value map, and verifies that all required keys are present and that their values are of expected types. The server rejects malformed payloads or logs an error if keys are missing.

Output: an internal input data object representing the user's space-related information and preference conditions.

### Step 5:

The server normalizes the input data into internal representation data.

Input: the internal input data object from Step 4.

The server converts all dimension values into a base unit (for example, millimeters) using arithmetic operations, such as multiplication by a conversion factor. The server trims leading and trailing spaces from string fields and converts them to a standard case (for example, lowercase) for comparison. The server maps free-text style descriptors and room shapes to controlled labels using lookup tables (for example, “modern and simple”-> “modern”, “rectangular room”-> “rectangular”). The server may infer default values, such as a default tool set for “beginner” skill level.

Output: an internal representation data object containing normalized and standardized values suitable for algorithmic processing.

### Step 6:

The server generates a prompt sentence using the internal representation data.

Input: the internal representation data object from Step 5.

The server selects a prompt template appropriate for the target object type (for example, a furniture template or a wearable template). The server fills template placeholders with fields from the internal representation data, such as room length, width, room shape, wall and floor colors, style, tool set, and skill level. The server performs string concatenation to create fluent sentences and may add specific constraints (for example, “provide measurements in millimeters” or “ensure stability for storing books”) based on rules encoded in the server.

Output: a complete prompt sentence in natural language that describes design requirements for a generative AI model.

### Step 7:

The server prepares and sends a request to the generative AI model.

Input: the prompt sentence generated in Step 6.

The server constructs a model request object including the prompt sentence and inference parameters such as maximum output length, temperature, and sampling strategy. The server serializes this object (for example, into JSON) and sends it via an HTTP or RPC call to an external model endpoint or to a local inference engine. The server sets model identifiers or configuration options so that the appropriate generative AI model instance is used.

Output: a model inference request transmitted to the generative AI model service.

### Step 8:

The server receives raw design text from the generative AI model.

Input: a response message from the generative AI model that was invoked in Step 7.

The server extracts generated text content from the response body. The server optionally logs the raw output for later analysis. The server then passes the text content to a parsing module without exposing it directly to the terminal.

Output: a raw design text string containing descriptions of dimensions, parts, materials, and assembly procedures as produced by the generative AI model.

### Step 9:

The server parses and structures the raw design text.

Input: the raw design text string from Step 8.

The server scans the text for section headings or patterns corresponding to dimensions, materials, parts lists, and assembly steps. The server uses pattern matching and regular expressions to identify lines describing part names, quantities, and numeric dimensions. The server splits the text into separate segments and converts them into structured data, such as arrays of parts with numeric fields for length, width, height, and quantity, and ordered lists of assembly steps. The server attaches unit information and flags entries where a unit is missing.

Output: structured design data including dimension information, component information, material information, and assembly procedure information.

### Step 10:

The server normalizes units and validates the structured design data.

Input: the structured design data from Step 9.

The server examines each numeric field and, when necessary, converts units (for example, inches to millimeters) using conversion formulas. The server checks that all dimensions are positive and within predefined practical ranges. The server verifies that parts referenced by assembly steps exist in the component list and that quantities are sufficient. When inconsistencies are detected, the server flags or annotates problematic entries and may perform corrective actions, such as inserting warnings into subsequent explanation text.

Output: validated and unit-normalized structured design data, with error flags or annotations where applicable.

### Step 11:

The server generates explanation information from the structured design data.

Input: the validated structured design data from Step 10.

The server assembles text sections to describe the design, including an overview, a component list, a required tool list, and stepwise work instructions. The server orders assembly steps logically, ensures each step contains a clear instruction verb and references to specific parts, and optionally splits long operations into smaller substeps. The server composes human-readable sentences from data fields using formatting functions and templates.

Output: explanation information as a collection of text blocks ready for display to the user.

### Step 12:

The server generates visualization information from the structured design data.

Input: the validated structured design data from Step 10.

The server computes geometric primitives representing parts such as boards and legs, using their dimensions and positional relationships (for example, distance from table edges). The server constructs two-dimensional outlines or three-dimensional meshes by calculating vertex coordinates and edges. The server packages this information as graphic data, such as vector drawing instructions or simple 3D model descriptions, which can be rendered on the terminal.

Output: visualization information describing at least one two-dimensional or three-dimensional representation of the target object.

### Step 13:

The server stores intermediate and final data for reuse.

Input: the internal representation data from Step 5, the prompt sentence from Step 6, and the structured design data from Step 10.

The server writes these data objects into a storage medium via a database interface, associating them with identifiers such as user ID and design ID. The server stores indexes that allow subsequent search and retrieval based on attributes such as room size, style, or furniture type. The server may also store logs of validation results and model parameters used for inference.

Output: persistent records that enable later retrieval, sharing, or modification of designs.

### Step 14:

The server packages and transmits response data to the terminal.

Input: the explanation information from Step 11 and the visualization information from Step 12.

The server constructs a response object containing the explanation text sections and graphic data, along with identifiers and optional metadata (for example, version number). The server serializes this response object (for example, into JSON plus embedded drawing instructions) and sends it as an HTTP response to the terminal over the network.

Output: a network response message containing design explanation and visualization data.

### Step 15:

The terminal receives and renders the design for the user.

Input: the network response message from the server in Step 14.

The terminal parses the response payload and updates its user interface to display the explanation information as readable text, lists, and stepwise instructions. The terminal invokes a graphics rendering component to draw the visualization information as diagrams or 3D views. The terminal enables user interactions such as scrolling through steps, zooming diagrams, and rotating 3D models.

Output: a displayed design interface that allows the user to understand the dimensions, required parts, tools, and assembly procedure of the target object.

### Step 16:

The user uses the displayed information to fabricate or simulate the target object.

Input: the explanation information and visualization information displayed by the terminal in Step 15.

The user reads the component list and required tool list to prepare materials and equipment, follows the stepwise work instructions during physical assembly, or initiates a virtual simulation for a wearable object in a virtual space. The user may optionally modify preferences on the terminal and restart the process to obtain variant designs.

Output: a physically constructed furnishing or article, or an executed simulation of a wearable object in a living or virtual space, based on the design generated by the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented design support systems suffer from several technical limitations when handling user-driven customization of three-dimensional objects such as furniture, general articles, and wearable articles. In many systems, user requirements are captured as simple parameter inputs or limited templates, and are not robustly integrated with unstructured multimodal input such as natural language, voice, images, body shape information, and emotion information. As a result, a processor must either rely on rigid parameter forms, or must treat natural language and other rich input merely as free text, which leads to ambiguous interpretation and frequent failures in mapping the input to consistent, machine-usable design specifications.

In addition, conventional use of generative AI models in design workflows often treats the models as black-box text generators. Such systems typically pass only a short textual instruction to the model and return unstructured textual output, leaving the host system with the heavy burden of post-processing. This causes technical problems in the processing pipeline of the information processing apparatus, such as: (i) difficulty in reliably extracting dimensional information, material information, and work procedure information from generated text, (ii) poor consistency of units and ranges, (iii) high computational overhead and latency for repeated parsing and validation, and (iv) difficulty in versioning and updating design data when incremental modifications are requested.

Further, many existing systems do not provide an integrated architecture by which the processor can: (i) collect domain data and environment data, (ii) construct rich, structured prompt sentences that condition the generative AI model on spatial conditions, physical conditions, and psychological states, (iii) convert the model's output directly into formal design information suitable for downstream use, and (iv) synchronize such design information across storage devices, online sharing platforms, display devices, and external manufacturing or distribution systems. The absence of such an architecture leads to technical issues including increased data inconsistency between devices, complex and error-prone glue code for coordinating multiple services, and poor responsiveness when regenerating or revising designs.

Moreover, emotion information and body shape information are not typically integrated into the low-level computation performed by the processor in conventional design systems. Emotion is often ignored or handled only at a superficial user-interface level, and body shape is often used only as a static size parameter. This means that the underlying computational processes of the processor cannot dynamically adjust design elements such as color, shape, and material based on an emotion vector, nor can the processor automatically compute shape parameters and arrangement parameters suitable for three-dimensional simulation in a virtual space. Consequently, the processor cannot efficiently generate optimized design information that reflects both the physical and psychological context of the user.

Accordingly, there is a need to improve computer technology in the field of design generation systems by providing a processor with specific configurations and processing flows that: (i) integrate multimodal user input into structured parameters, (ii) construct and manage prompt sentences for a generative AI model in a systematic and repeatable way, (iii) directly formalize the output of the generative AI model into machine-usable design information with clear dimensional and procedural structure, (iv) maintain synchronized storage and sharing of design versions, and (v) compute emotion vectors and three-dimensional models so that design information is technically optimized for visualization, simulation, and manufacturing. The technical problem to be solved is, therefore, to provide an information processing architecture and processing sequence that improves the reliability, consistency, and efficiency of computer-based generation, revision, visualization, and distribution of design information using a generative AI model and structured prompt sentences.

The specific processing by the specific processing unit 290 of the data processing device 12 in Application Example 2 is realized by the following means.

The present invention provides a server comprising a processor configured to collect attribute information and environment information regarding multiple types of three-dimensional objects and cause a machine learning model, including a generative AI model, to learn from the collected information; to receive, from a terminal, multimodal user input including natural language requests, voice input, image input, body shape information, and emotion information; to extract, from the multimodal user input, structured parameters representing spatial conditions, physical conditions, and psychological states; to construct a prompt sentence including the structured parameters and to input the prompt sentence to the generative AI model; to analyze text data output from the generative AI model, to formalize the text data as design information including dimensional information, material information, and work procedure information, and to convert the design information into electronic data in a format of a drawing, a procedure document, or a manufacturing instruction document; to store the drawing, the procedure document, or the manufacturing instruction document in association with metadata in a storage device and, in accordance with publication control information, to register the design information as searchable design data on an online sharing platform; to transmit the design information to the terminal as two-dimensional display data or three-dimensional display data so that the design information is visually presented on a display device or an augmented reality display device of the terminal; to receive, from the terminal, a design modification request or evaluation information, to identify existing design information, to construct an update prompt sentence including the existing design information and the design modification request, to input the update prompt sentence to the generative AI model, to generate revised design information, and to update contents stored in the storage device and registered on the online sharing platform with the revised design information; and to receive, based on the design information, a manufacturing request or a download request for an article, to generate manufacturing data or distribution data corresponding to the request, and to transmit the manufacturing data or the distribution data to an external device or an external service. This enables the server to technically improve the end-to-end design generation pipeline by systematically integrating multimodal user input into structured prompt sentences, by directly transforming generative AI model output into machine-usable design data with consistent dimensions and procedures, by maintaining synchronized storage and shared access to design versions, and by supporting efficient regeneration, visualization, simulation, and manufacturing of customized three-dimensional objects in a computer-implemented environment.

The term “processor” refers to a hardware-based or virtualized computation unit that executes machine-readable instructions to perform data acquisition, data processing, model inference, and control operations within the system.

The term “machine learning model” refers to a computational model whose parameters are trained using data so as to perform prediction, classification, generation, or transformation of information based on input data.

The term “generative AI model” refers to a machine learning model configured to generate new information, such as text, numerical values, or structural descriptions, in response to an input prompt sentence or conditioning data.

The term “generative AI model extension” refers to a software component or configuration that augments a generative AI model with additional capabilities, such as domain-specific knowledge, conditioning on structured parameters, or integration with external data sources.

The term “terminal” refers to an information processing device, such as a portable terminal, a stationary terminal, or a head-mounted display device, that acquires user input, communicates with the server, and presents output information to the user.

The term “user input” refers to information provided by a human user to the system, including but not limited to natural language text, voice data, image data, body shape information, and emotion information.

The term “natural language request” refers to a sentence or sequence of sentences expressed in a human language that describes a user's design requirements, preferences, or constraints.

The term “voice input” refers to audio data captured from a user's speech and processed by speech recognition or audio analysis to obtain textual content or acoustic features.

The term “image input” refers to digital image data or video frames captured by an imaging device, used to derive information such as spatial conditions, body shape information, or facial expressions.

The term “body shape information” refers to parameters representing physical characteristics of a user's body, such as height, width, circumference, or proportions, which may be estimated from images or other sensors.

The term “emotion information” refers to data indicating a psychological or affective state of a user, such as joy, sadness, fatigue, or calmness, derived from voice tone, facial expression, text content, or other signals.

The term “structured parameters” refers to data elements organized in a predefined format, such as numerical values, categorical labels, or key-value pairs, that represent spatial conditions, physical conditions, or psychological states in a machine-usable form.

The term “spatial conditions” refers to information describing a physical environment or space, including dimensions, shapes, colors, layouts, and other environmental attributes relevant to placement or sizing of three-dimensional objects.

The term “physical conditions” refers to information indicating physical characteristics or constraints related to a user or an environment, such as body measurements, reachability, or available floor space.

The term “psychological states” refers to internal mental or emotional conditions of a user, such as mood, preference tendencies, or stress level, which may influence design decisions.

The term “prompt sentence” refers to a text sequence constructed by the processor that encodes user requirements, structured parameters, and control instructions, and is supplied as input to the generative AI model to guide generation of design information.

The term “design information” refers to data describing a configuration of a three-dimensional object, including dimensional information, material information, and work procedure information, suitable for visualization, simulation, or manufacturing.

The term “dimensional information” refers to numerical values and relationships specifying sizes, positions, and geometric properties of components of an object, such as lengths, widths, heights, and angles.

The term “material information” refers to data indicating types of substances or components to be used in manufacturing or assembly of an object, including categories such as wood, metal, textile, or synthetic material, and their properties.

The term “work procedure information” refers to data describing steps, sequences, and operations required to manufacture, assemble, or configure an object, including instructions, order of operations, and tool usage.

The term “electronic data in a format of a drawing” refers to digital information representing a two-dimensional or three-dimensional graphical representation of an object, such as vector data, raster data, or computer-aided design data.

The term “procedure document” refers to an electronic document that records work procedure information in a human-readable form, such as step-by-step instructions or diagrams, for producing or assembling an object.

The term “manufacturing instruction document” refers to an electronic document that provides machine-usable or human-usable instructions, specifications, and parameters required for manufacturing or producing an object.

The term “metadata” refers to auxiliary information associated with design information, including identifiers, timestamps, categories, style labels, emotion labels, access control information, and other descriptive attributes.

The term “storage device” refers to a hardware or virtualized memory system, such as a non-volatile storage unit or a database system, that stores design information, metadata, and related electronic data.

The term “publication control information” refers to data indicating whether and how design information is to be made accessible to other users, including flags, permissions, and access policies.

The term “online sharing platform” refers to a network-based service that stores design information and makes it discoverable and accessible to one or more users through communication networks.

The term “searchable design data” refers to design information stored together with metadata in such a way that it can be located and retrieved using search queries or filtering conditions.

The term “two-dimensional display data” refers to data formatted for presentation of design information on a planar display, including images, diagrams, or layouts suitable for rendering in two dimensions.

The term “three-dimensional display data” refers to data formatted for rendering a three-dimensional representation of design information, including mesh data, scene descriptions, or volumetric data.

The term “display device” refers to a hardware component that visually outputs images or graphics to a user, such as a flat-panel display or a projection device.

The term “augmented reality display device” refers to a device configured to overlay computer-generated images or information onto a view of a real environment, such as smart glasses or a head-mounted display.

The term “design modification request” refers to information specifying a change or adjustment that a user wishes to apply to existing design information, including changes to dimensions, materials, or style.

The term “evaluation information” refers to feedback data provided by a user regarding generated design information, such as ratings, comments, or qualitative assessments.

The term “update prompt sentence” refers to a prompt sentence constructed to instruct the generative AI model to revise existing design information based on a design modification request and context of a prior design.

The term “revised design information” refers to design information that has been regenerated or modified by the processor and the generative AI model in response to a design modification request.

The term “manufacturing request” refers to a request specifying that a physical article corresponding to design information should be produced by a manufacturing system or service.

The term “download request” refers to a request specifying that electronic data representing design information should be provided to a user or another system for local storage or use.

The term “manufacturing data” refers to data including parameters, geometries, and instructions suitable for direct use by manufacturing equipment or production management systems to produce an article.

The term “distribution data” refers to electronic data prepared for delivery of design information or related content to a user or external system, including file bundles, URLs, or access tokens.

The term “external device” refers to a computing device or control system outside the server that receives manufacturing data or distribution data, such as a production controller or a client terminal.

The term “external service” refers to a network-accessible service separate from the server, such as a manufacturing service, printing service, or content distribution service, that processes manufacturing data or distribution data.

The term “emotion vector” refers to a numerical representation of a user's emotion information, structured so as to quantify one or more emotional dimensions for use in adjusting design elements.

The term “design elements related to color, shape, or material” refers to attributes of an object's appearance or structure, including color schemes, geometric styling, curvature, texture, and material assignments that can be modified based on an emotion vector.

The term “wearable articles” refers to articles intended to be worn on a human body, such as garments, accessories, or protective equipment.

The term “shape parameters” refers to numerical or categorical values defining geometric properties of an object or wearable article, such as size, contour, thickness, or curvature.

The term “arrangement parameters” refers to data describing how an object or wearable article is positioned, oriented, or placed relative to a body or an environment.

The term “three-dimensional model” refers to a digital representation of an object or article in three dimensions, including its geometry, surface properties, and optionally animation or rigging information.

The term “virtual space” refers to a computer-generated environment in which three-dimensional models can be displayed, manipulated, or simulated independently of the physical world.

In one embodiment, a server executes an integrated design generation system that cooperates with one or more terminals operated by a user. The server comprises at least one hardware processor, a main memory, a non-volatile storage device, a network interface, and one or more machine learning accelerators such as graphics processing units. The terminal comprises a processor, a memory, an imaging device such as a camera, a microphone, and a display device or an augmented reality display device, such as a head-mounted display.

The server executes a software stack including an operating system, an application server implemented for example with a general-purpose server framework, a database management system, a machine learning framework such as a tensor-based computation library, and one or more generative AI model inference engines. The terminal executes an application implemented with a cross-platform user interface framework, an audio capture and encoding library, an image capture and processing library such as a general-purpose computer vision library, and an optional three-dimensional graphics engine for rendering two-dimensional or three-dimensional display data.

The server maintains in the storage device a data repository containing attribute information and environment information regarding multiple types of three-dimensional objects. The attribute information includes high-level descriptors such as object category (for example, furniture, general article, wearable article), usage category, and style category; and low-level structural descriptors such as component identifiers, component connectivity, parametric dimensions, and allowable tolerance ranges. The environment information includes spatial configuration templates (for example, room size ranges, body size distributions), color palettes, material catalogs, and empirical constraints such as ergonomic ranges for heights and widths.

The server implements a data collection and learning module that uses the machine learning framework to train a machine learning model including a generative AI model. In one configuration, the generative AI model is implemented as a transformer-based neural network with an encoder-decoder architecture. The server represents each training sample as a pair of input sequence and target sequence. The input sequence encodes a structured prompt sentence that describes spatial conditions, physical conditions, and psychological states; the target sequence encodes a canonicalized design specification expressed as a sequence of tokens.

The server tokenizes prompt sentences and target design specifications using a subword tokenization scheme. The server embeds tokens into continuous vectors and feeds them into a multi-layer transformer architecture comprising a plurality of self-attention layers, feed-forward layers, and layer normalization units. The server computes an output token distribution at each time step and compares it with the target tokens using a cross-entropy loss function. The server updates the model weights using a gradient-based optimization algorithm such as stochastic gradient descent with momentum or an adaptive learning-rate variant. The server optionally applies data augmentation at the token level, including synonym replacement for style descriptions, small perturbations of dimensional parameters within a safe range, and reordering of non-dependent procedural steps, in order to increase the robustness of the model.

The server stores the trained generative AI model parameters in the storage device and loads them into the machine learning accelerator when performing inference. The server further maintains an index of training data, model versions, and evaluation metrics, and periodically retrains or fine-tunes the model when additional attribute information and environment information become available. By explicitly structuring the training data and modeling pipeline, the server improves prediction accuracy of dimensions and materials and reduces the number of post-processing corrections compared with a naïve text-only generation approach.

The terminal acquires user input in multiple modalities. The user operates the terminal to provide a natural language request, such as by speaking into the microphone or by typing text. The terminal digitizes the voice input, encodes it into an audio format, and sends it to a speech recognition module, either locally or on the server. The speech recognition module converts the voice input into text, which the terminal normalizes by applying language-specific tokenization, number normalization (for example, converting “three meters” to “3 m”), and basic error correction.

The user further operates the terminal to capture image input. For example, the user captures a view of a room, a view of a body, or a facial expression. The terminal passes the image input through the image processing library to detect edges, estimate camera pose, identify human body joints, and segment objects. The terminal derives initial estimates of room width, room depth, and significant surfaces, or derives estimates of height, shoulder width, chest circumference, and other body shape parameters. The terminal may also extract facial landmarks, compute facial expression features, and estimate a coarse emotion label. The terminal packages the normalized natural language request, the image-derived parameters, and optional raw or compressed image data into a structured message and transmits the message to the server. The server receives the message through the network interface and stores a log of the input in the storage device for traceability and later learning. The server executes a parameter extraction module that converts unstructured or semi-structured user input into structured parameters. The parameter extraction module includes a natural language processing component and a feature fusion component. The natural language processing component is implemented as either a rule-based parser with domain-specific grammars or a neural sequence labeling model trained to recognize entities such as length, width, height, color, style, and use case. The server extracts entities such as “3 m by 4 m,” “white walls,” “dark brown flooring,” “modern style,” and “simple T-shirt,” and normalizes them into a canonical representation.

The feature fusion component receives numeric features from the image processing, such as estimated dimensions, body shape vectors, and expression features, and merges them with the linguistic entities. The server then computes spatial conditions, physical conditions, and psychological states as structured parameters. For example, the server may derive spatial conditions as a tuple (room_width, room_depth, wall_color, floor_color), physical conditions as a body vector (height, shoulder_width, chest_circumference), and psychological states as an emotion vector with components corresponding to joy, fatigue, relaxation, and other dimensions. The server may compute the emotion vector using a classifier network that takes as input facial features and prosodic features and outputs a probability distribution over discrete emotions, which the server then projects into a continuous vector space.

The server constructs a prompt sentence for the generative AI model by combining the structured parameters with textual templates and control tokens. The server uses deterministic rules to insert labels and delimiters so that the generative AI model can reliably parse the input. For example, the server may construct a prompt sentence as:

“The user's room is 3 m by 4 m with white walls and dark brown flooring. The user's emotion is tired and wants to relax. Design a modern-style table that fits this room, with dimensions suitable for daily use, and propose calming colors and materials. Output a clear, structured furniture design specification.”

In another example, when the user provides a body shape request, the server may construct a prompt sentence as:

“User's body shape parameters: height 170 cm, chest 95 cm, shoulders 45 cm. The user wants a simple, comfortable T-shirt that fits well and feels relaxed. Design a T-shirt pattern with detailed measurements, fabric suggestions, and seam instructions.”

In another example, when the user emphasizes emotional context, the server may construct a prompt sentence as:

“User emotion: tired and seeking relaxation. Design a piece of lounge furniture that promotes relaxation, using soft shapes and calm colors. Provide dimensions, materials, and a step-by-step DIY assembly recipe.”

The server can further construct a revision-oriented prompt sentence when the user provides feedback, such as:

“Revise the previous design. Reduce the table height from 75 cm to 70 cm and choose a lighter wood species while keeping a modern style suitable for a 3 m by 4 m room with white walls and dark brown flooring.”

By enforcing such structured prompt sentence formats, the server reduces ambiguity in the generative AI model input, simplifies parsing of the output, and improves processing speed because fewer iterations of error correction are required.

The server supplies the constructed prompt sentence and, if supported by the implementation, the structured parameters as auxiliary conditioning vectors to the generative AI model. The server uses the machine learning framework to embed the prompt sentence into a token sequence, applies positional encoding, and feeds it into the transformer layers. When auxiliary vectors such as the body shape vector or emotion vector are used, the server injects them into the model through a conditioning mechanism, such as concatenation with the prompt embeddings, use of special control tokens, or modulation of intermediate activations via a learned adapter network.

The server executes the forward pass of the generative AI model on the machine learning accelerator and obtains an output token sequence. The server decodes the sequence into text and applies a constrained decoding strategy which restricts the vocabulary and sequence structure for certain sections such as dimension tables and bill of materials. For example, the server may use a grammar-constrained decoder for portions that must follow a “parameter_name: numeric_value unit” pattern. This reduces output variability and allows deterministic extraction of dimensional information and material information.

The server then executes a design formalization module that converts the textual output into design information. The design formalization module parses sections of the generated text based on predefined markers, for example, “DIMENSIONS:”, “MATERIALS:”, and “STEPS:”. The server scans each section and creates data structures such as arrays of dimension tuples, lists of material records, and ordered step descriptions. The server applies validation functions that check for unit consistency, value ranges, and geometric coherence. If a dimension falls outside a safe ergonomic range, the server may either flag an error or employ a correction rule that snaps the dimension to the nearest allowed value.

The server transforms the formalized design information into one or more electronic formats. For a furniture design, the server may generate a parameterized vector representation of a table, including top length, top width, leg positions, and thicknesses. The server may pass these parameters into a drawing generation module that outputs a vector graphic drawing or a CAD-compatible file. For a T-shirt design, the server may map the measurements to a pattern template and output a 2D layout of panels as an electronic document.

The server associates each design with metadata including a unique identifier, timestamps, category labels, style labels, emotion labels, and access control flags. The server stores the design information and related files in the storage device managed by the database system and file storage subsystem. The server records the original prompt sentence and structured parameters so that subsequent modifications can reference them.

The server registers the design on an online sharing platform if the metadata indicates public availability. The server creates search indices based on keywords extracted from the design description, categories, style labels, and numeric filters such as room size range or body size range. The server thereby enables other terminals to search and retrieve design information efficiently without scanning entire documents, which reduces network bandwidth and improves query latency.

The terminal receives the design information and associated display data from the server. When a simple two-dimensional display is sufficient, the terminal renders text and drawings in panels of the user interface. When three-dimensional display data is provided, the terminal loads the mesh data or parametric data into its graphics engine. The terminal may then render a three-dimensional model that the user can rotate, zoom, or place in a virtual representation of a room.

In a configuration where the terminal is an augmented reality display device, the terminal aligns the three-dimensional model with the physical environment using camera pose tracking and environment reconstruction. The terminal overlays the design at a chosen position in the room so that the user can visually inspect how the proposed object fits within the actual space. The server can optionally precompute level-of-detail representations of the three-dimensional model to reduce rendering load on constrained devices, thereby improving frame rates and user experience.

The user interacts with the displayed design and provides feedback through the terminal. For example, the user may input natural language such as “Make the table 20 cm shorter and use a lighter wood,” adjust sliders for height or width, or toggle color options. The terminal converts this feedback into structured modification parameters and sends them to the server. The server identifies the referenced design based on the unique identifier, merges the modification parameters with the original structured parameters, and constructs a new update prompt sentence that explicitly describes the changes.

The server then re-invokes the generative AI model with the update prompt sentence, optionally conditioning on the original design information as context. Because the server uses a differential description of changes and a preserved context of the prior design, the model can generate a coherent revision without regenerating unrelated parts, which reduces compute time and avoids unnecessary variations. The server again formalizes, validates, and stores the revised design information and notifies the terminal.

In some embodiments, the server computes an emotion vector from the emotion information and uses it explicitly in the prompt sentence. By doing so, the server can systematically adjust design elements such as color, curvature, and material softness. For example, when the emotion vector indicates that the user is tired, the server can bias the generative AI model toward low-saturation colors, rounded shapes, and soft materials by indicating in the prompt sentence that the design should promote relaxation. This is different from a human designer's manual operation because the server applies a mathematically defined mapping from the emotion vector to prompt sentence content and to design parameters, which yields a reproducible and quantifiable modification of the model's behavior.

From a technical perspective, the server improves the internal data handling of design generation in several ways. The structured parameter extraction and constrained prompt sentence construction reduce the entropy of the input sequence to the generative AI model, leading to faster convergence of the model during inference and fewer decoding errors. The grammar-constrained decoding and deterministic post-parsing allow direct mapping from generated tokens to typed design fields, which reduces parsing complexity and error rates. The use of auxiliary vectors for emotion and body shape enables the model to capture cross-modal correlations that a human designer would need to learn manually and that simple rule-based systems cannot capture.

The system provides technical effects such as reduced processing latency, improved design accuracy, and lower communication load. Because the server can store and reuse structured parameters and partial designs, regeneration of variations often requires sending only small modification messages instead of full descriptive texts, which reduces network traffic. The deterministic structuring of prompt sentences and model outputs also allows the server to cache frequently used patterns and perform partial evaluation, further reducing computation load on the machine learning accelerators.

The server can be implemented in various alternative forms. In one variant, the server uses a sequence-to-sequence generative AI model with recurrent neural network layers instead of a transformer architecture. In another variant, the server uses a hybrid architecture where a discriminative model scores candidate designs generated by a base model, selecting the design that best matches physical and psychological constraints. The emotion vector may be computed by a shallow classifier or a deeper convolutional or transformer model, depending on resource constraints.

The terminal can also be implemented in different configurations. A simple terminal may only capture text and display two-dimensional drawings, whereas an advanced terminal may integrate depth cameras and inertial sensors to obtain more accurate spatial conditions and provide more precise augmented reality overlays. The core architecture described above remains applicable, because the server continues to receive multimodal input, extract structured parameters, construct prompt sentences, invoke the generative AI model, and formalize the design information.

In all these embodiments, the server, the terminal, and the user cooperate so that the system not only automates human design tasks but also improves computer technology itself by refining how the processor structures and processes data, interacts with generative AI models, and coordinates storage, visualization, and external device control. The described configurations allow a skilled person to implement the invention and to achieve the stated technical effects in terms of accuracy, efficiency, and robustness of computer-based design generation.

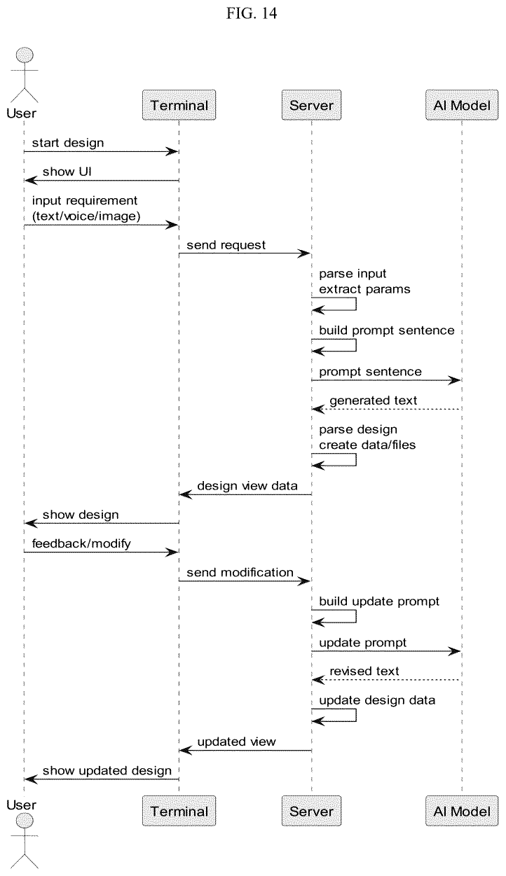

The following describes the processing flow using FIG. 14.

### Step 1:

User operates the terminal to start a design session and select a design category.

User provides input by tapping a menu item such as “furniture,” “general article,” or “wearable article” on the terminal screen.

Terminal receives, as input, a user selection event indicating the chosen category and an internal session identifier.

Terminal performs data processing by updating an internal session state structure (for example, setting fields such as ‘taskType=furniture’, ‘sessionId=S001’) and loading a corresponding user interface layout.

Terminal outputs an updated UI context and a stored session state that will be attached to subsequent user input.

### Step 2:

User provides design requirements to the terminal via natural language.

User speaks into the microphone, for example: “The room is 3 meters by 4 meters, the walls are white, the flooring is dark brown. Please design a modern-style table.”

Alternatively, User types text such as: “I want a simple T-shirt that fits my body shape.”

Terminal receives, as input, either raw audio data or raw text data together with the current session state.

Terminal performs data processing by encoding audio into a digital format, forwarding the audio to a speech recognition function, and normalizing the recognized text (number normalization, removal of extra spaces, basic spell checking).

Terminal outputs a normalized textual requirement string, such as “The room is 3 m by 4 m with white walls and dark brown flooring. Design a modern style table,” or “I want a simple T-shirt that fits my body shape.”

### Step 3:

User optionally uses the terminal to capture environmental or body images.

User points the camera toward a room or body and presses a capture button following on-screen guidance.

Terminal receives, as input, one or more image frames or short video clips along with the normalized textual requirement and session state.

Terminal performs data processing by applying an image-processing pipeline: (i) running edge detection and line detection to estimate wall boundaries and floor plane for room images, or (ii) running pose estimation and contour extraction for body images to estimate body shape parameters such as height and shoulder width.

Terminal outputs structured numeric parameters (for example, ‘room Width=3.0’, ‘roomDepth=4.0’, ‘wallColorImage=white’, ‘floorColorImage=dark brown’, or ‘height=170’, ‘shoulderWidth=45’) and optionally reduced or compressed image data for reference.

### Step 4:

User optionally expresses emotional context through voice or facial expression.

User says phrases such as “I'm tired today” or “I had a great day,” while looking toward the camera.

Terminal receives, as input, additional audio and video frames associated with the ongoing session.

Terminal performs data processing by extracting audio features (pitch, energy, speaking rate) and facial features (eyebrow movement, mouth curvature, eye openness) and forwarding these features to an emotion classification function. The classification function computes an emotion label (for example, “tired,” “joyful”) and a confidence score.

Terminal outputs an emotion information record, such as ‘{emotion=tired, confidence=0.83}’, associated with the session.

### Step 5:

Terminal assembles a multimodal request and transmits it to the server.

Terminal receives, as input, the normalized text, numeric parameters from image processing, emotion information, and session state.

Terminal performs data processing by packaging these elements into a structured message (for example, a JSON-like object with fields for ‘taskType’, ‘textRequirement’, ‘spatialParams’, ‘bodyShapeParams’, and emotionInfo) and tagging the message with a unique transaction identifier.

Terminal outputs a network request containing the structured message and sends it to the server via a communication interface.

### Step 6:

Server receives the multimodal request and parses the contained data.

Server receives, as input, the structured message from the terminal, including text requirements, spatial parameters, body shape parameters, emotion information, and session identifiers.

Server performs data processing by validating message structure, decoding character encodings, and storing a log entry in a request log table with a timestamp and user identifier. Server outputs an internal representation object that holds the request data in server-local data structures for further processing.

### Step 7:

Server extracts entities and structured parameters from the textual requirement.

Server receives, as input, the normalized text requirement string and the internal representation object.

Server performs data processing by applying a natural language processing module that tokenizes the text, applies part-of-speech tagging, and runs entity extraction to detect dimensions (for example, “3 m by 4 m”), colors (for example, “white,” “dark brown”), style descriptors (for example, “modern,” “simple”), and object types (for example, “table,” “T-shirt”). The server converts detected phrases into standardized numeric and categorical values.

Server outputs structured parameters representing spatial conditions (for example, ‘room Width=3.0’, ‘roomDepth=4.0’, ‘wallColor=white’, ‘floorColor=dark brown’), object category (for example, ‘objectType=table’), and style (for example, ‘style=modern’), and stores them in the internal representation object.

### Step 8:

Server fuses image-derived parameters and emotion information with text-derived parameters.

Server receives, as input, text-derived structured parameters, image-derived numeric parameters, body shape parameters, and emotion information.

Server performs data processing by reconciling and merging values: for example, if room width from text is 3.0 m and from image is 3.1 m, the server may compute a weighted average or apply a rule to prefer measured values within a tolerance. The server encodes physical conditions as vectors (for example, a body shape vector), and encodes emotion information as an emotion vector with components corresponding to emotional dimensions.

Server outputs unified structured parameters, including spatial conditions, physical conditions, and psychological states, all normalized and stored as fields in the internal representation object.

### Step 9:

Server constructs a prompt sentence that conditions the generative AI model.

Server receives, as input, unified structured parameters and session context such as task type and object category.

Server performs data processing by selecting a template corresponding to the task type (for example, furniture template, wearable template) and inserting parameter values into template slots. The server also appends control phrases specifying required output structure, such as “Provide dimensions, materials, and a step-by-step assembly recipe.”

Server outputs a fully constructed prompt sentence. Examples include:

“The user's room is 3 m by 4 m with white walls and dark brown flooring. The user's emotion is tired and wants to relax. Design a modern-style table that fits this room, with dimensions suitable for daily use, and propose calming colors and materials. Output a clear, structured furniture design specification.”

“User's body shape parameters: height 170 cm, chest 95 cm, shoulders 45 cm. The user wants a simple, comfortable T-shirt that fits well and feels relaxed. Design a T-shirt pattern with detailed measurements, fabric suggestions, and seam instructions.”

“User emotion: tired and seeking relaxation. Design a piece of lounge furniture that promotes relaxation, using soft shapes and calm colors. Provide dimensions, materials, and a step-by-step DIY assembly recipe.”

Server stores the prompt sentence in association with the request.

### Step 10:

Server invokes the generative AI model using the constructed prompt sentence.

Server receives, as input, the prompt sentence and, optionally, auxiliary vectors such as the body shape vector and emotion vector.

Server performs data processing by tokenizing the prompt sentence, embedding tokens into vectors, and feeding them through the layers of the generative AI model (for example, self-attention layers and feed-forward layers). The server conditions intermediate representations with auxiliary vectors using mechanisms such as concatenation or learned adapters. The generative AI model computes, at each token position, probability distributions over the vocabulary and selects tokens according to a decoding strategy that may include temperature adjustment and grammar constraints for sections that must follow specific patterns.

Server outputs a generated text sequence, which is decoded into natural language segments, including descriptions, dimension blocks, material lists, and procedural steps.

### Step 11:

Server parses the generative AI model output into structured design information.

Server receives, as input, the generated text sequence from the generative AI model and the initial prompt sentence.

Server performs data processing by scanning the text for section markers (for example, “DIMENSIONS:”, “MATERIALS:”, “STEPS:”) and splitting the text accordingly. For each section, the server applies parsers: for dimensions, the server extracts parameter names, numeric values, and units; for materials, the server extracts material types and quantities; for steps, the server enumerates lines as ordered procedures. The server validates units and ranges (for example, confirming that table height is within ergonomic limits) and may correct minor inconsistencies by applying predefined adjustment rules.

Server outputs structured design information, including dimensional information arrays, material information lists, and ordered work procedure information, all stored as typed fields in a design data object.

### Step 12:

Server generates electronic drawing data, procedure documents, and manufacturing instruction documents.

Server receives, as input, structured design information and the design data object.

Server performs data processing by mapping dimensional information to geometric primitives; for example, the server creates vector shapes representing table tops and legs or pattern panels for T-shirts. The server uses a drawing engine or CAD kernel to generate two-dimensional drawings and, where applicable, three-dimensional meshes based on the parameters. The server formats work procedure information and material lists into human-readable procedure documents and machine-readable manufacturing instruction documents.

Server outputs multiple electronic data formats: a drawing file or graphic data, a procedure document, and a manufacturing instruction document, which are linked to the design data object.

### Step 13:

Server stores design data and registers it on an online sharing platform.

Server receives, as input, the design data object, including drawings, procedure documents, manufacturing instructions, and associated metadata.

Server performs data processing by writing metadata and structural fields to a database, storing binary files in a file storage system, and generating indexed keys based on category, style, size, and emotion labels. The server applies access control rules based on publication flags to decide whether design data is private or public. For public designs, the server adds entries to a searchable index.

Server outputs persistent records in the storage system and an identifier or URL that can be used by terminals and other services to retrieve the design.

### Step 14:

Server generates display data tailored to the terminal and sends it for visualization.

Server receives, as input, the design data object and information about the terminal's display capabilities (for example, two-dimensional display only, or three-dimensional and augmented reality support).

Server performs data processing by selecting appropriate resolution and format for drawings, converting three-dimensional meshes into reduced-detail or specific formats as needed, and packaging textual summaries and key parameters into a display-oriented structure. The server may compress large assets and generate multiple levels of detail for efficient rendering.

Server outputs a response payload containing two-dimensional display data, three-dimensional display data, and summary information, and transmits this payload to the terminal over the network.

### Step 15:

Terminal renders the design data and provides an interactive interface.

Terminal receives, as input, the payload containing display data and summary information from the server.

Terminal performs data processing by parsing the payload, loading text into user interface components, and initializing a rendering pipeline for drawings or three-dimensional models. When three-dimensional or augmented reality display is available, the terminal loads meshes into a graphics engine, sets up camera views, and, if in AR mode, estimates device pose relative to the environment to place the model correctly.

Terminal outputs visual content on its display device or augmented reality display device, showing drawings, three-dimensional views, or overlaid AR models, and makes interactive controls (for example, rotation, zoom, sliders, and text input fields) available to the user.

### Step 16:

User inspects the displayed design and provides feedback or modification requests.

User views the drawings or three-dimensional models on the terminal and interacts with UI controls. User may say: “Make the table 20 cm shorter and use a lighter wood,” adjust a slider for height, or change a drop-down selection for color.

Terminal receives, as input, these interactions in the form of natural language text, control events, and updated parameter values.

Terminal performs data processing by transforming UI events into a structured modification request: mapping slider changes to dimension deltas, mapping color choices to color labels, and converting natural language feedback into textual modification descriptions. Terminal associates the modification request with the design identifier and current version.

Terminal outputs a structured modification message and sends it to the server as a new request.

### Step 17:

Server regenerates or adjusts the design using an update prompt sentence.

Server receives, as input, the structured modification message and the identifier of the existing design.

Server performs data processing by retrieving the original structured parameters and design information from the database, merging them with the new modification parameters, and constructing an update prompt sentence that describes both the existing design context and the requested changes. For example, the server may create a prompt sentence such as: “Revise the previous design. Reduce the table height from 75 cm to 70 cm and choose a lighter wood species while keeping a modern style suitable for a 3 m by 4 m room with white walls and dark brown flooring.” The server then invokes the generative AI model again, parses the new output into revised design information, and re-generates drawings and documents as in previous steps.

Server outputs revised design data and updated electronic files, stores them, and transmits updated display data back to the terminal so the user can review the modifications.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

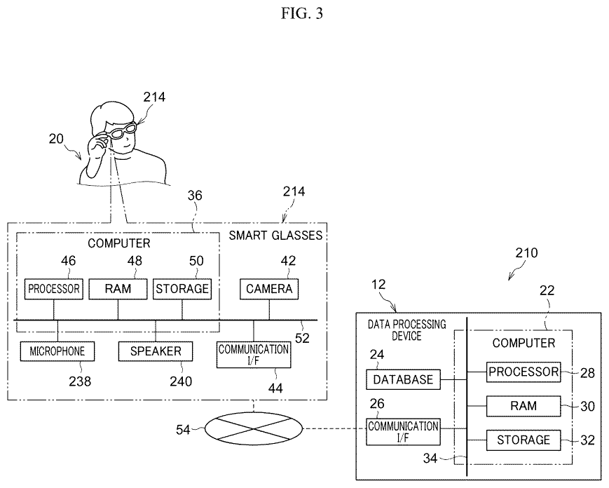

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

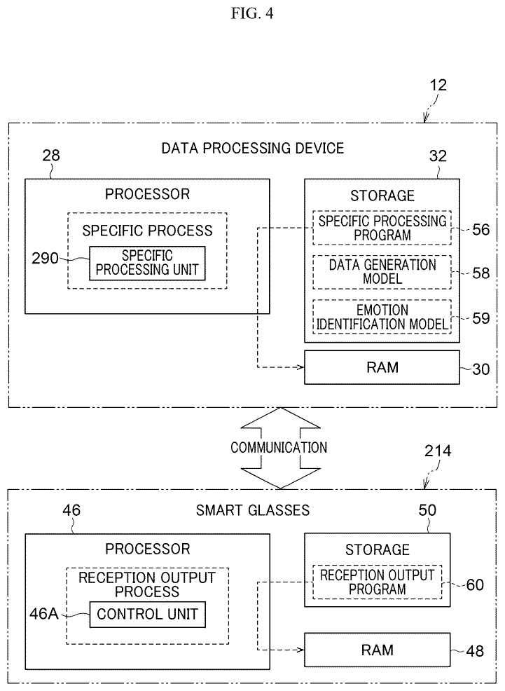

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

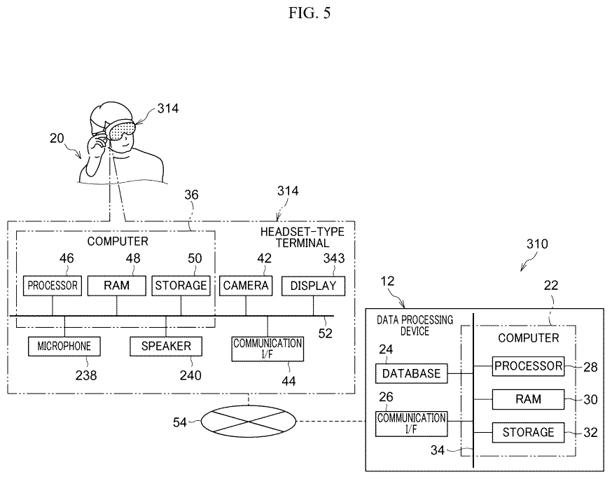

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

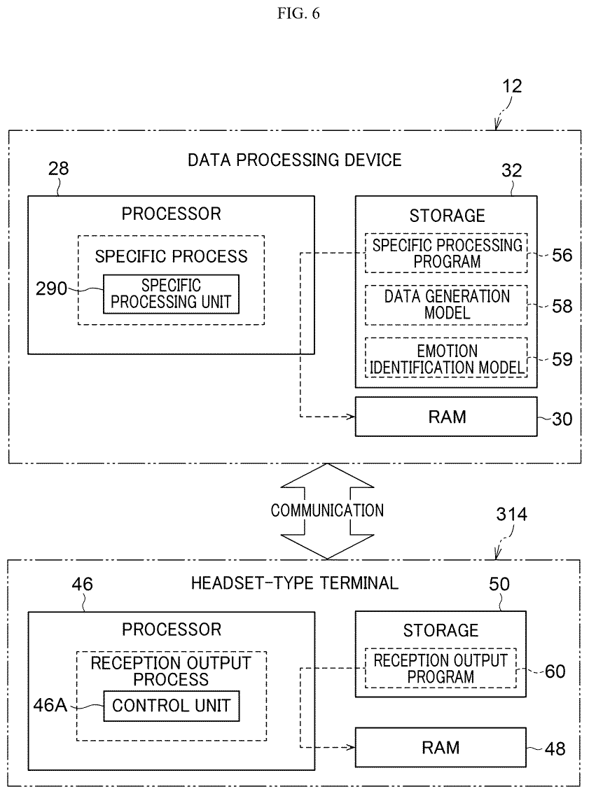

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

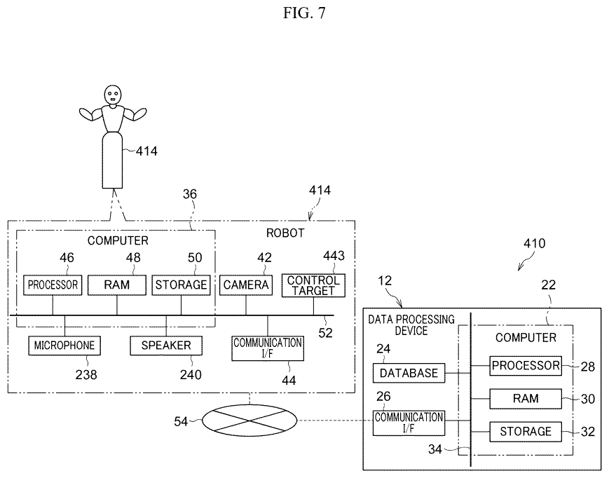

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

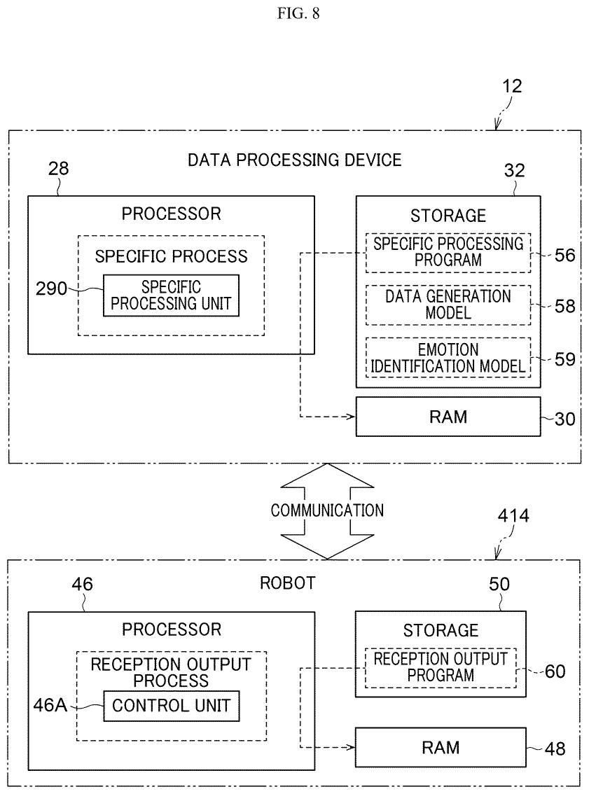

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

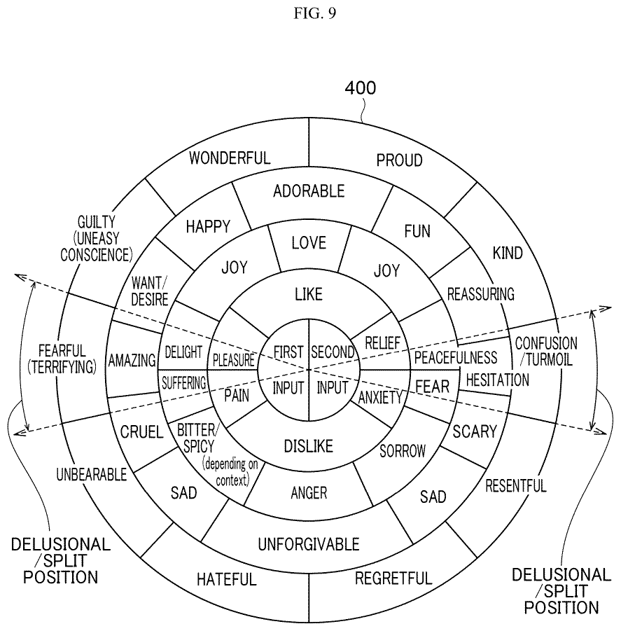

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

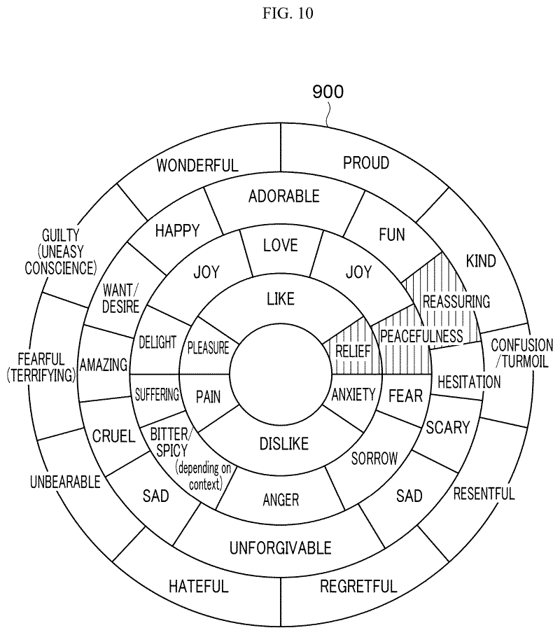

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire an information set including attribute information relating to an article, and record the information set as structured information including the attribute information and image information in a storage device in order to provide learning information to a generative artificial intelligence model,
train the generative artificial intelligence model by using a machine learning framework on the basis of the structured information and update parameters of the generative artificial intelligence model so that the generative artificial intelligence model is capable of outputting design information of the article in response to an input of a prompt sentence,
obtain, via a communication device, the prompt sentence described in natural language from a user, and convert the prompt sentence into an internal representation that is inputtable to the generative artificial intelligence model,
input the internal representation to the generative artificial intelligence model and cause the generative artificial intelligence model to generate the design information including design parameters and external shape parameters of the article corresponding to the prompt sentence, perform three-dimensional shape generation processing on the basis of the design information to generate three-dimensional model data representing the article, and output the three-dimensional model data in a standardized digital data format, and
store the three-dimensional model data and the design information in association with management information in the storage device, and distribute the three-dimensional model data and the design information as publication information via an online platform so that the three-dimensional model data and the design information are shareable among a plurality of users.

### (Supplementary 2)

The system according to supplementary 1,
wherein the processor is configured to
transmit the three-dimensional model data to a terminal of the user, enable the three-dimensional model data to be displayed by three-dimensional display software in the terminal, obtain dimension change information or appearance change information from the user, update the design information on the basis of the dimension change information or the appearance change information, and repeatedly execute processing of regenerating the three-dimensional model data on the basis of the updated design information.

### (Supplementary 3)

The system according to supplementary 1,
wherein the processor is configured to
train the generative artificial intelligence model on the basis of attribute information common to a plurality of article categories including furniture, general articles, garments, and other articles, identify an article category included in the prompt sentence, generate the design information and the three-dimensional model data in accordance with the identified article category, generate placement information of the three-dimensional model data in a virtual space, and cause the placement information and the three-dimensional model data to be displayed on the online platform.

### Application Example 1

### (Supplementary 1)

A system comprising a processor and a terminal,
wherein the terminal is configured to receive a prompt sentence in natural language from a user, to transmit the prompt sentence to a server including the processor, and to display a virtual space based on three-dimensional object data and scene configuration information transmitted from the server,
wherein the processor is configured to execute a generative AI model as an auxiliary function of generative artificial intelligence on a storage resource and a computation resource, to store in an external storage a set of object data including attribute data related to furnishing and other articles, and to train the generative AI model based on the set of object data,
wherein the processor is configured to apply natural language processing to the prompt sentence received from the terminal, to convert the prompt sentence into structured information indicating a type of object, a style, a target placement space, and attribute conditions, and to generate, based on the structured information, a model-input prompt sentence to be input to the generative AI model,
wherein the processor is configured to execute the generative AI model based on the model-input prompt sentence and the set of object data to generate three-dimensional object data or parametric design information including shape information, appearance information, and material information of an object, and to store a result of the generation in digital form in the storage resource,
wherein the processor is configured to convert the three-dimensional object data or the parametric design information into a three-dimensional data format loadable by display-processing software capable of generating a virtual space, to calculate, based on a predetermined environment template, a placement position and an orientation of the object in the virtual space, and to generate scene configuration information in which the object is placed at the placement position and the orientation,
wherein the processor is configured to output, via an online path, the three-dimensional data format of the object data and the scene configuration information as a data format transmittable to the terminal, thereby enabling visual confirmation and placement simulation in the virtual space by the terminal,
wherein the processor is configured, when an additional prompt sentence is received via the terminal from the user, to analyze the additional prompt sentence in association with existing structured information and the three-dimensional object data, to extract modification parameters related to at least one of shape, dimension, color, and placement position, to regenerate or modify the three-dimensional object data based on the modification parameters, and to output updated scene configuration information to the terminal again so as to perform iterative design adjustment, and
wherein the processor is configured to store generated designs in association with identification information, original prompt sentences, and attribute information, and to make the generated designs referable and shareable from a third-party terminal via an information-providing platform for publication.

### (Supplementary 2)

The system according to supplementary 1,
wherein the processor is configured to generate procedure information including work steps, materials to be used, and dimensional information for producing the object in a physical space based on design information of the object generated by the generative AI model, and to transmit the procedure information to the terminal for display so as to support production of a physical article by the user.

### (Supplementary 3)

The system according to supplementary 1,
wherein the processor is configured to store, as the set of object data, data related to wearable articles and other articles in addition to data related to furnishing, to train the generative AI model on the entire set of object data, and to generate, in response to the prompt sentence, designs of multiple types of objects including placement simulation in the virtual space.

### Example 2

### (Supplementary 1)

A system comprising a processor,
wherein the processor is configured to
acquire, via a terminal device, space-related information and preference conditions regarding a target object, the space-related information and the preference conditions being input by a user in natural language or as numerical values, and to obtain input data including the space-related information and the preference conditions, and
analyze the input data including the space-related information and the preference conditions, normalize the input data into internal representation data, and generate, based on the internal representation data, a prompt sentence described in natural language that specifies instructions to a generative AI model of a generative artificial intelligence, the prompt sentence being dynamically generated using a template, and
input the prompt sentence to the generative AI model and invoke the generative AI model via an external information processing resource or an internal information processing resource, and cause the generative AI model to generate design data including design information of a furnishing or an article based on the prompt sentence, and
analyze the design data obtained from the generative AI model, extract dimension information, component information, material information, and assembly procedure information from the design data, convert the extracted information into structured data, and generate, based on the structured data, explanation information and visualization information in a format understandable to the user, and
transmit, via a network, the explanation information and the visualization information to the terminal device, and cause the terminal device to display the explanation information and the visualization information such that the user is assisted in manually producing the furnishing or the article adapted to the space, and
store the internal representation data, the prompt sentence, and the design data in a storage medium, and enable sharing or re-use of the design data in an online environment by using data stored in the storage medium.

### (Supplementary 2)

The system according to supplementary 1,
wherein the processor is configured to
cause the explanation information to include a component list, a required tool list, and stepwise work instructions generated based on the dimension information and the component information included in the structured data, cause the visualization information to include two-dimensional or three-dimensional graphic data generated based on the dimension information, and enable the user to produce the furnishing or the article by following the component list and the work instructions.

### (Supplementary 3)

The system according to supplementary 1,
wherein the processor is configured to
acquire, as part of the input data, information relating to a wearable object including arrangement conditions and decoration conditions in a living space or a virtual space, and cause the generative AI model, based on the prompt sentence, to generate design data including design information of the wearable object and simulation information of arrangement or wearing in the living space or the virtual space.

### Application Example 2

### (Supplementary 1)

A system comprising a processor,
wherein the processor is configured to
collect attribute information and environment information regarding multiple types of three-dimensional objects, and cause a machine learning model, including a generative AI model extension, to learn from the collected information, and
receive, from a terminal, user input including natural language requests, voice input, image input, body shape information, and emotion information, extract structured parameters representing spatial conditions, physical conditions, and psychological states of a user from the user input, and construct a prompt sentence including the structured parameters, and input the prompt sentence to the generative AI model, and
analyze text data output from the generative AI model, formalize the text data as design information including dimensional information, material information, and work procedure information, and convert the design information into electronic data in a format of a drawing, a procedure document, or a manufacturing instruction document, and
store the drawing, the procedure document, or the manufacturing instruction document in association with metadata in a storage device, and, in accordance with publication control information, register the design information as searchable design data on an online sharing platform, and
transmit the design information to the terminal as two-dimensional display data or three-dimensional display data, so that the design information is visually presented on a display device or an augmented reality display device of the terminal, and
receive, from the terminal, a design modification request or evaluation information, identify existing design information, construct an update prompt sentence including the existing design information and the design modification request, input the update prompt sentence to the generative AI model, generate revised design information, and update contents stored in the storage device and registered on the online sharing platform with the revised design information, and
receive, based on the design information, a manufacturing request or a download request for an article, generate manufacturing data or distribution data corresponding to the request, and transmit the manufacturing data or the distribution data to an external device or an external service.

### (Supplementary 2)

The system according to supplementary 1,
wherein the processor is configured to
generate an emotion vector for adjusting design elements related to color, shape, or material based on the emotion information, append the emotion vector to the prompt sentence, input the prompt sentence to the generative AI model, and thereby generate design information optimized in accordance with an emotional state of the user.

### (Supplementary 3)

The system according to supplementary 1,
wherein the processor is configured to
calculate shape parameters and arrangement parameters for wearable articles based on the body shape information and the spatial conditions, generate a three-dimensional model from the design information output from the generative AI model, and provide, to the terminal, display data enabling simulation of a wearing state or a placement state of the three-dimensional model in a virtual space.

What is claimed is:

1. A system comprising:
circuitry configured to:
receive, via a communication interface coupled to a packet-switched network, natural language dialogue input from a terminal device, and generate a structured internal representation from the natural language dialogue input by normalizing and extracting attribute information and dimensional constraints;
generate a prompt sentence based on the structured internal representation, input the prompt sentence to a generative AI model to generate design data including at least a structure specification and associated procedure information, and validate the design data against production constraints stored in a storage device; and
transmit the validated design data to the terminal device via the communication interface, and store the design data and the structured internal representation in the storage device.

2. The system according to claim 1, wherein the circuitry is configured to receive natural language dialogue input from the terminal device representing a description of a desired article, normalize units, check numerical values for plausibility and consistency, and generate the structured internal representation incorporating the normalized attribute information.

3. The system according to claim 2, wherein the circuitry is configured to apply template filling and rule-based processing to the structured internal representation to generate the prompt sentence, and incorporate specific constraints including unit specifications and assembly requirements into the prompt sentence.

4. The system according to claim 3, wherein the circuitry is configured to receive design data from the generative AI model, perform structured post-processing including parsing of the design data against defined schemas, and verify completeness of component lists relative to assembly steps.

5. The system according to claim 4, wherein the circuitry is configured to generate a visualization of the design data by converting the validated design data into compact visualization instructions, transmit the visualization instructions to the terminal device for rendering, and reconstruct the user interface from the compact representation.

6. The system according to claim 1, wherein the circuitry is configured to train a generative AI model using learning data including attribute information and image information of a plurality of articles stored in the storage device, and maintain the trained model for use in generating design data.

7. The system according to claim 6, wherein the circuitry is configured to acquire an information set including attribute information relating to an article, record the information set as structured information in the storage device, and use the stored structured information as learning information for the generative AI model.

8. The system according to claim 1, wherein the circuitry is configured to receive, from the terminal device, a modification request specifying a change to the generated design data, generate an updated prompt sentence incorporating the modification request and the original structured internal representation, and obtain updated design data from the generative AI model.

9. The system according to claim 8, wherein the circuitry is configured to generate variant designs from the stored internal representation without reconstructing the entire generation pipeline, and transmit the variant designs to the terminal device for selection.

10. The system according to claim 1, wherein the circuitry is configured to validate numerical values in the generated design data for plausibility and consistency, convert units as needed, and ensure completeness of parts lists relative to assembly steps prior to transmission to the terminal device.

11. The system according to claim 10, wherein the circuitry is configured to detect inconsistencies in the generated design data by comparing component specifications against assembly step requirements, and regenerate the prompt sentence to request corrected design data from the generative AI model.

12. The system according to claim 1, wherein the circuitry is configured to publish validated design data to a shared data platform via the communication interface to enable sharing of design data with other users.

13. The system according to claim 12, wherein the circuitry is configured to receive, from the shared data platform via the communication interface, design data published by other users, store the received design data in the storage device, and make the stored design data available as additional learning information for the generative AI model.

14. The system according to claim 1, wherein the circuitry is configured to generate manufacturing data for physical fabrication based on the validated design data, and transmit the manufacturing data to a fabrication interface via the communication interface.

15. The system according to claim 14, wherein the circuitry is configured to validate the manufacturing data against production constraints prior to transmission to the fabrication interface, and detect and correct dimensional inconsistencies in the manufacturing data.

16. The system according to claim 1, wherein the circuitry is configured to store the prompt sentence and design data in the storage device with defined schemas to enable regeneration of visualizations, modification of designs, and generation of variant designs without reconstructing the generation pipeline.

17. The system according to claim 16, wherein the circuitry is configured to retrieve stored prompt sentences and design data from the storage device, and use the retrieved data to generate variant designs by adjusting dimensional or material parameters in the structured internal representation.

18. A system comprising:
circuitry configured to:
receive, via a communication interface coupled to a packet-switched network, natural language dialogue input from a terminal device, normalize and extract attribute information and dimensional constraints, and generate a structured internal representation;
generate a prompt sentence incorporating the structured internal representation, input the prompt sentence to a generative AI model to generate design data, and perform structured post-processing to validate the design data against production constraints;
transmit compact visualization instructions derived from the validated design data to the terminal device via the communication interface; and
store the structured internal representation, the prompt sentence, and the validated design data in a storage device for subsequent retrieval and reuse.

19. The system according to claim 18, wherein the circuitry is configured to receive a modification request from the terminal device specifying a change to the generated design data, generate an updated prompt sentence incorporating the modification request, and obtain updated design data from the generative AI model without reconstructing the generation pipeline.

20. A method comprising:
receiving, via a communication interface coupled to a packet-switched network, natural language dialogue input from a terminal device, and generating a structured internal representation from the natural language dialogue input by normalizing and extracting attribute information and dimensional constraints;
generating a prompt sentence based on the structured internal representation, inputting the prompt sentence to a generative AI model to generate design data, and validating the design data against production constraints; and
transmitting the validated design data to the terminal device via the communication interface, and storing the design data and the structured internal representation in a storage device.
